(19) United States
(12) Patent Application Publication
(10) Pub. No.: US 2026/0087386 A1
(43) Pub. Date: Mar. 26, 2026

(54) USING CACHED EXPERTS IN MIXTURE OF EXPERTS (MOE)

(71) Applicant: QUALCOMM Incorporated, San Diego, CA (US)

(72) Inventors: Andrii SKLIAR, Diemen (NL); Babak EHTESHAMI BEJNORDI, Amsterdam (NL); Ties Jehan VAN ROZENDAAL, Amsterdam (NL); Marinus Willem VAN BAALEN, Amsterdam (NL); Markus NAGEL, Amsterdam (NL); Paul Nicholas WHATMOUGH, Cambridge, MA (US)

(21) Appl. No.: 19/017,238

(22) Filed: Jan. 10, 2025

Related U.S. Application Data
(60) Provisional application No. 63/699,708, filed on Sep. 26, 2024.

(51) Int. Cl. G06N 5/043; G06N 20/00

(52) U.S. Cl. CPC G06N 5/043; G06N 20/00

(57) ABSTRACT

Systems and techniques are described herein for processing tokens. For instance, a method for processing tokens is provided. The method may include processing a token at a router model to generate a recommendation a subset of expert models from a plurality of expert models to use for further processing of the token; selecting a number of expert models to use for the further processing of the token based on the recommendation of the subset of expert models and based on cached expert models of the plurality of expert models stored in a cache memory; and processing the token using the selected number of expert models.

### CROSS-REFERENCE TO RELATED APPLICATIONS

This application claims the benefit of U.S. Provisional Application No. 63/699,708, filed Sep. 26, 2024, which is incorporated herein by reference in its entirety.

### TECHNICAL FIELD

The present disclosure generally relates to machine-learning models. For example, aspects of the present disclosure relates to using cached experts in mixture of experts (MOE) for machine-learning processing (e.g., language processing, vision or image processing, multi-modal models with a language decoder, such as vision language models, etc.).

### BACKGROUND

Deep-learning machine-learning models (e.g., neural networks, such as large language models (LLMs)) can be used to perform a variety of tasks, such as detection and/or recognition of natural language, and natural-language processing, among other natural-language tasks. Deep-learning machine-learning models can be versatile and can achieve high-quality results in a variety of tasks. However, while deep-learning machine-learning models can be versatile and accurate, the models can be large and slow, and generally have high memory demands and computational costs. In many cases, the computational complexity of the models can be high, and the models can be difficult to train. In some cases, machine-learning models may utilize one or more transformers. Tokens are used by a transformer as its base units for reasoning. For example, a natural-language word may be associated with a token, which can be input into the transformer for processing.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Systems and techniques are described for processing tokens. According to at least one example, a method is provided for processing tokens. The method includes: processing a token at a router model to generate a recommendation a subset of expert models from a plurality of expert models to use for further processing of the token; selecting a number of expert models to use for the further processing of the token based on the recommendation of the subset of expert models and based on cached expert models of the plurality of expert models stored in a cache memory; and processing the token using the selected number of expert models.

In another example, an apparatus for processing tokens is provided that includes at least one memory and at least one processor (e.g., configured in circuitry) coupled to the at least one memory. The at least one processor configured to: process a token at a router model to generate a recommendation a subset of expert models from a plurality of expert models to use for further processing of the token; select a number of expert models to use for the further processing of the token based on the recommendation of the subset of expert models and based on cached expert models of the plurality of expert models stored in a cache memory; and process the token using the selected number of expert models.

In another example, a non-transitory computer-readable medium is provided that has stored thereon instructions that, when executed by one or more processors, cause the one or more processors to: process a token at a router model to generate a recommendation a subset of expert models from a plurality of expert models to use for further processing of the token; select a number of expert models to use for the further processing of the token based on the recommendation of the subset of expert models and based on cached expert models of the plurality of expert models stored in a cache memory; and process the token using the selected number of expert models.

In another example, an apparatus for processing tokens is provided. The apparatus includes: means for processing a token at a router model to generate a recommendation a subset of expert models from a plurality of expert models to use for further processing of the token; means for selecting a number of expert models to use for the further processing of the token based on the recommendation of the subset of expert models and based on cached expert models of the plurality of expert models stored in a cache memory; and means for processing the token using the selected number of expert models.

In some aspects, one or more of the apparatuses described herein is, can be part of, or can include an extended reality device (e.g., a virtual reality (VR) device, an augmented reality (AR) device, or a mixed reality (MR) device), a vehicle (or a computing device, system, or component of a vehicle), a mobile device (e.g., a mobile telephone or so-called “smart phone”, a tablet computer, or other type of mobile device), a smart or connected device (e.g., an Internet-of-Things (IoT) device), a wearable device, a personal computer, a laptop computer, a video server, a television (e.g., a network-connected television), a robotics device or system, or other device. In some aspects, each apparatus can include an image sensor (e.g., a camera) or multiple image sensors (e.g., multiple cameras) for capturing one or more images. In some aspects, each apparatus can include one or more displays for displaying one or more images, notifications, and/or other displayable data. In some aspects, each apparatus can include one or more speakers, one or more light-emitting devices, and/or one or more microphones. In some aspects, each apparatus can include one or more sensors. In some cases, the one or more sensors can be used for determining a location of the apparatuses, a state of the apparatuses (e.g., a tracking state, an operating state, a temperature, a humidity level, and/or other state), and/or for other purposes.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative examples of the present application are described in detail below with reference to the following figures:

FIG. 1 is a diagram illustrating a comparison between an example dense model (e.g., in the form of a dense expert transformer) and an example sparse model (e.g., in the form of a sparse expert transformer);

FIG. 2 shows an example of routers routing respective tokens to particular experts;

FIG. 3 is a diagram illustrating an example system including memory, a random-access memory (RAM), and a processor;

FIG. 4 includes a block diagram illustrating an example process of selecting experts in response to an example string of tokens;

FIG. 5A is a block diagram illustrating an example system for determining experts, in accordance with aspects of the present disclosure;

FIG. 5B is a diagram illustrating an example scenario in which the systems and techniques may determine experts based on a recommendation of a router and based on cached experts, according to various aspects of the present disclosure;

FIG. 5C is a diagram illustrating an example scenario in which the systems and techniques may determine experts based on a recommendation of a router and based on cached experts, according to various aspects of the present disclosure;

FIG. 6A is a diagram illustrating an example scenario in which the systems and techniques may determine experts based on a recommendation of a router and based on cached experts, according to various aspects of the present disclosure;

FIG. 6B is a diagram illustrating an example scenario in which the systems and techniques may determine experts based on a recommendation of a router and based on cached experts, according to various aspects of the present disclosure;

FIG. 7 is a diagram illustrating an example system for determine experts based on a recommendation of a router multi-layer perceptron (MLP) and based on cached experts, according to various aspects of the present disclosure;

FIG. 8 is a diagram illustrating an example system for determine experts based on a recommendation of a router MLP and based on cached experts, according to various aspects of the present disclosure;

FIG. 9 is a diagram illustrating an example system for determine experts based on a recommendation of a router MLP and based on cached experts mt, according to various aspects of the present disclosure;

FIG. 10 is a block diagram illustrating an example system for processing tokens, in accordance with aspects of the present disclosure;

FIG. 11 is a flow diagram illustrating an example process for processing tokens, in accordance with aspects of the present disclosure;

FIG. 12 is a block diagram of an example transformer, according to various aspects of the present disclosure;

FIG. 13 is a block diagram illustrating an example of a deep learning neural network that can be used to perform various tasks, according to some aspects of the disclosed technology;

FIG. 14 is a block diagram illustrating an example of a convolutional neural network (CNN), according to various aspects of the present disclosure; and

FIG. 15 is a block diagram illustrating an example computing-device architecture of an example computing device which can implement the various techniques described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the exemplary aspects will provide those skilled in the art with an enabling description for implementing an exemplary aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage, or mode of operation.

As previously mentioned, deep-learning machine-learning models (e.g., neural networks, such as transformer-based neural networks, including large language models (LLMs)) can be used to perform a variety of tasks, such as natural-language processing (e.g., detection, recognition, generation, etc. of natural language), vision processing (e.g., image and/or video processing), among other tasks. Deep-learning machine-learning models can be versatile and can achieve high quality results in a variety of tasks. While deep-learning machine-learning models can be versatile and accurate, the models can be large and slow. For example, deep-learning machine-learning models typically have high memory demands and computational complexity/costs, which can make such models difficult to train.

In some cases, machine-learning models may include one or more transformer models. Tokens can be utilized by a transformer model as its base unit for reasoning. For example, a natural-language word can be associated with a token, which can be input into the transformer for processing. A transformer model improves language processing with its unique architecture. The transformer architecture has two main non-embedding components, including an attention component and a feedforward network (FFN). For example, the attention component captures interdependencies between words (e.g., natural language words), while the FFN non-linearly transforms each input token (e.g., each associated with a word) independently.

The FFN enhances the capability of the transformer to handle diverse and complex linguistic tasks with efficiency and effectiveness. The FFN includes two linear fully connected layers (e.g., a multi-layer perceptron (MLP)) that transform the input data. Positioned within both the encoder and decoder modules of the transformer, the FFN refines data processed by the attention mechanisms of the transformer. By systematically refining the output from the attention layers of the transformer, the FFN helps to maintain high performance of the transformer across different natural-language processing applications.

The capacity of a machine-learning model (e.g., a neural network) to absorb information is limited by the number of parameters of the model. As a consequence, finding more effective ways to increase model parameters has become a trend in deep learning research.

Mixture of Experts (MOE) is a machine learning technique that combines multiple specialized sub-networks (experts), which work together to solve specific tasks. MOE is a type of conditional computation where parts of the network are activated on a per-example basis. MOE models can be used as a way to dramatically increase model capacity without a proportional increase in computation. For example, in sparsely activated variants of MOE models, a subset of experts is selected on a per-token (or per-example) basis, which creates sparsity in the network. Such models have demonstrated better scaling in multiple domains and better retention capability in a continual learning setting.

MOE models operate by adopting a number of experts (e.g., with each expert being a sub-network) and activating one or more experts for each input token. A gating network (e.g., a router or routing network) can be optimized to route each token to the most suited expert(s) for a given token. Depending upon how tokens are mapped to experts, MOE models can be sparse or dense. Sparse MOE models only select a subset of experts when routing each token, which reduces computational cost as compared to dense MOE models.

Transformer-based neural networks (e.g., LLMs) improve machine intelligence by enabling a wide range of processing tasks, such as natural language processing tasks, vision processing tasks, etc. However, deploying LLMs and other transformer-based models on some devices (e.g., mobile devices) presents a challenge due to the large number of parameters and significant memory and compute costs of LLMs. The use of MOE models can significantly increase the number of parameters in a machine-learning model (e.g., an LLM) without a proportional increase in computation during training and inference. Such computational efficiency can be achieved by selectively activating (e.g., as in a sparse model) only a subset of parameters (or experts) for each input. MOE models for LLMs can be designed by replacing an FFN layer in a transformer block with a set of expert FFN layers. As noted above, an MOE model can include a gating/routing mechanism (e.g., a router or routing network) that dynamically determines which expert (or combination of experts) is best suited for a given input during inference.

MOE models can be trained for batch deployment on servers (e.g., for inference) or the like, running across a large number of devices, where each device hosts a single (or a subset) of experts. Deployment of MOE models in servers may provide scalability and efficiency, allow for batch deployment, and allow for parallelization. For example, a server deployment of an MOE model may enable LLMs (or other models) to be scaled up significantly without a proportional increase in computational costs. Additionally server-deployed MOE models can process multiple user requests simultaneously, maximizing graphics processing unit (GPU) resource utilization and improving throughput. Additionally, server-deployed MOE model architectures facilitate parallelization across multiple devices, allowing different experts to be placed on different servers or GPUs.

However, MOE models may require a large amount of memory. For example, during on-device inference, all of the model parameters are loaded in random-access memory (RAM). For example, given an MOE architecture (e.g., Mixtral 8x7B), there needs to be enough RAM, such as video random-access memory (VRAM), to store a dense parameter model (e.g., a dense 47B parameter model, corresponding to 22 gigabytes (GB) in 4-bit).

Memory-constrained devices (e.g., mobile devices, extended reality (XR) devices, etc.) may not have enough RAM to be able to load all of the model parameters in RAM. Alternative solutions may be needed for memory-constrained devices, such as caching of the experts.

Caching may involve storing experts in memory, then loading a selected subset of experts from the memory into RAM for use. For example, a system may include a first memory type (e.g., a flash memory) and a second memory type, such RAM (e.g., dynamic RAM (DRAM)). The attention weights may be loaded into RAM. A subset of the experts may be loaded into RAM at any given time. For example, a router may select which experts may be used to process a given token. The experts may be loaded into RAM and used to process the given token.

However, the lack of consistency in activation of experts in the temporal dimension can lead to a significant cache miss rate. For example, the router may select different experts from one token to the next. Loading and evicting experts from RAM may be computationally expensive (e.g., in terms of power, processing time, and/or bandwidth).

Systems, apparatuses, methods (also referred to as processes), and computer-readable media (collectively referred to herein as “systems and techniques”) are described herein for using cached experts. For example, the systems and techniques described herein may determine experts to use to process tokens in a way that favors using cached experts.

Various aspects of the application will be described with respect to the figures below. Illustrative and non-limiting aspects and examples related to the present disclosure are included in Appendix A attached hereto, which is incorporated herein by reference in its entirety for all purposes.

As previously mentioned, deep-learning machine-learning models, such as LLMs, may be employed to perform a variety of tasks (e.g., detection and/or recognition of natural language, and natural language processing, among other natural language tasks). Deep-learning machine-learning models are versatile and may achieve high-quality accurate results in a variety of tasks. However, deep-learning models can be large and slow and can have large memory and computational costs. The computational complexity of deep-learning models can be high, and deep-learning models can be difficult to train. In one or more cases, machine-learning models can employ one or more transformers. Tokens can be used by a transformer as its base units for reasoning. For example, a natural language word can be associated with a token, which can be input into the transformer for processing.

Advances in machine learning, especially in natural language, have been achieved by increasing the computational budget, training data, and model size. Training state-of-the-art models, however, requires thousands of specialized, interconnected accelerators for weeks or months at a time. The models are therefore expensive to produce and incur high energy costs. As the scale of machine-learning systems has increased, more efficient training and serving paradigms have been sought, such as sparse models.

LLMs enable a wide range of natural language processing tasks. However, deploying LLMs on mobile devices presents challenges due to their enormous parameter sizes and significant memory and compute costs. Using MOE models (e.g., for LLMs or other types of machine-learning models) can increase the number of parameters in a model (e.g., an LLM) without a proportional increase in computation during training and inference. For example, computational efficiency can be achieved by selectively activating (e.g., as in a sparse model) only a subset of parameters (or experts) for each input. Although MOE models (e.g., in a sparse model) provide computational benefits, as compared to dense models, MOE models have several challenges for training and on-device inference.

Currently, sparse expert models are a popular architecture in deep learning. The sparse expert model class of architecture encompasses MOE. An MOE layer in an MOE architecture can include a set of experts, a routing mechanism (e.g., a routing network), and an optional loss function to balance the assignment of tokens to experts. For example, an MOE model for an LLM may be designed by replacing an FFN layer in a transformer block with a set of expert FFN layers. The MOE model can include a gating/routing mechanism (e.g., a router or routing network) that dynamically determines which expert (or combination of experts) is best suited for a given input during inference. A switch transformer is a variant of an MOE layer using top-1 routing instead of top-k routing (where k≥2). Using a sparse expert model, the degree of sparsity decouples the parameter count from a compute per example allowing for extremely large, but efficient models. The resulting models have demonstrated significant improvements across diverse domains, such as natural language processing, computer vision, and speech recognition.

Sparse expert models, such as MOE models, are neural networks where a set of the parameters are partitioned into “experts,” each with a unique weight. During training and inference, the models route input examples to specific expert(s) weights. As a result, each example only interacts with a subset of the network parameters, converse to the usual approach, where the entire network is used for each input. Because only a fraction of the experts are used for each example, the amount of computation may remain small relative to the total model size.

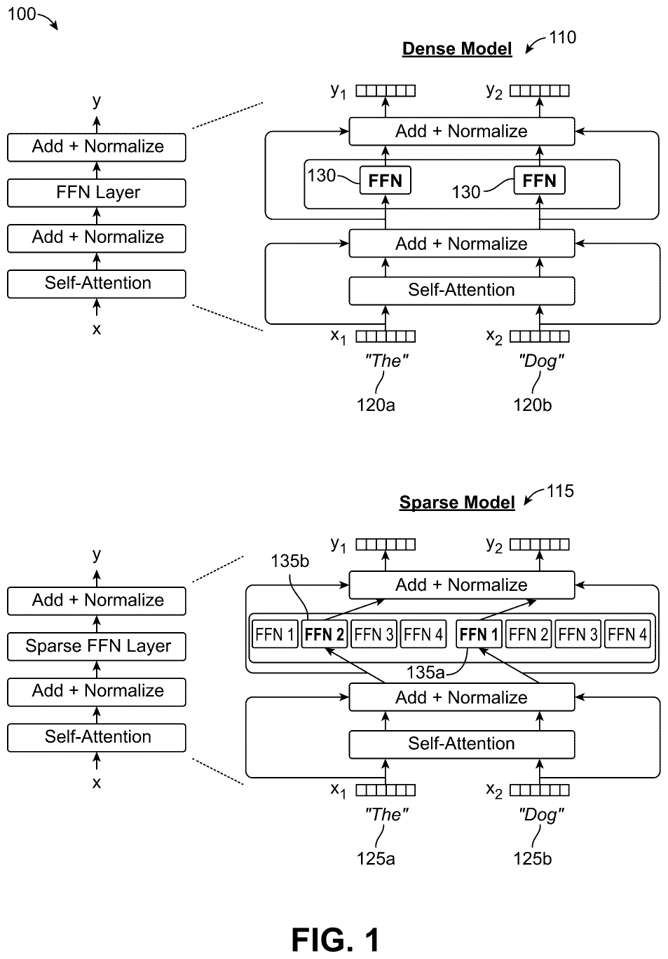

FIG. 1 is a diagram illustrating a comparison 100 between an example dense model 110 (e.g., in the form of a dense expert transformer) and an example sparse model 115 (e.g., in the form of a sparse expert transformer). In FIG. 1, tokens 120a, 120b and tokens 125a, 125b can be used by the dense model 110 and the sparse model 115 (respectively) as base units for reasoning. For example, a natural language word (e.g., “the” or “dog”) or portion thereof can be associated with each a token 120a, 120b, 125a, 125b, which can be input into the dense model 110 and the sparse model 115 for processing.

In FIG. 1, the dense model 110 is shown to send both input tokens 120a, 120b (e.g., associated with the natural language words “the” and “dog”, respectively) to the same FFNs 130. Conversely, the sparse model 115 is shown to route each input token 125a, 125b (e.g., associated with the natural language words “the” and “dog”, respectively) independently amongst four experts (e.g., FFN 1 135a, FFN 2 135b, FFN 3, FFN 4). For example, in FIG. 1, the sparse model 115 is shown to route token 125a (e.g., associated with the natural language word “the”) to FFN 2 135b, and the sparse model 115 is shown to route token 125b (e.g., associated with the natural language word “dog”) to FFN 1 135a. In FIG. 1, each transformer (e.g., each of the dense model 110 and the model 115) uses a similar amount of computation, but the sparse model 115 has more unique parameters (e.g., experts) than the dense model 110.

As previously mentioned, the capacity of a neural network to absorb information is limited by the number of its parameters, and as a consequence, finding more effective ways to increase model parameters has become a trend in deep learning research. MOE (e.g., a type of conditional computation where parts of the network are activated on a per-example basis) has been used to dramatically increase model capacity without a proportional increase in computation. In sparsely activated variants of MOE models (e.g., the sparse model 115 in FIG. 1), a subset of experts is selected on a per-token (or per-example) basis, which creates sparsity in the network. Such models have demonstrated better scaling in multiple domains, and better retention capability in a continual learning setting.

MOE models (e.g., a sparse model) enable models to be pretrained with far less compute, which means that the model or dataset size can be dramatically scaled up with the same compute budget as a dense model. In particular, an MOE model should achieve the same quality as its dense counterpart much faster during pretraining. In the context of transformer models, MOEs include two main elements, including sparse MOE layers and a gate network or router. The terms “gate network” and “router” may be used interchangeably and/or may otherwise be used synonymously throughout various aspects described herein. The sparse MOE layers are used instead of dense FFN layers. MOE layers have a certain number of experts (e.g., eight experts), where each expert is a neural network. In practice, the experts are FFNs, but they can also be more complex networks or even an MOE itself.

MOEs operate by adopting a number of experts, each as a sub-network, and activating only one (or a few experts) for each input token. A gating network (e.g., a router or routing network) may be chosen and optimized in order to route each token to the most suited expert(s). Sparse MOEs (e.g., a sparse model) only select a subset of experts when routing each token, which reduces computational cost as compared to dense MOEs (e.g., a dense model).

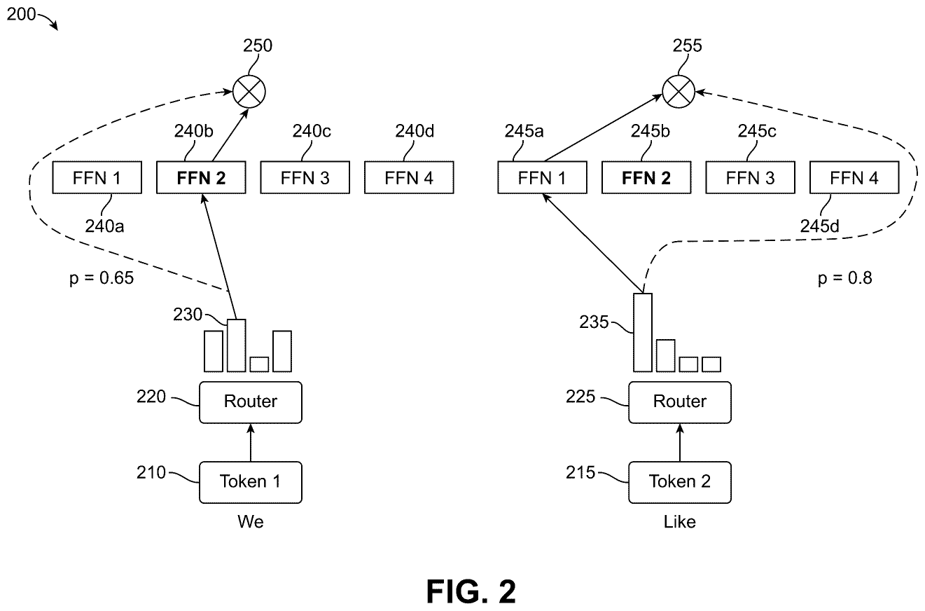

A gate network (which may alternatively be referred to as a router) determines which tokens are sent to which expert(s). FIG. 2 shows an example of routers 220, 225 routing respective tokens 210, 215 to particular experts (e.g., FFN 2 240b and FFN 1 245a). In particular, FIG. 2 is a diagram illustrating an example of MOE token choice routing. In FIG. 2, a sparse switch FFN layer 200 is shown. A sparse MOE layer may employ the sparse switch FFN layer 200 of FIG. 2.

The sparse switch FFN layer 200 operates independently on the tokens 210, 215 in a sequence. The tokens 210, 215 are each associated with a natural language word (or portion thereof). For example, token 210 is shown to be associated with the natural language word “we”, and token 215 is shown to be associated with the natural language word “like.”

In FIG. 2, the two tokens 210, 215 are shown to be routed across four FFN experts (e.g., among FFN 1 240a, FFN 2 240b, FFN 3 240c, and FFN 4 240d; and among FFN 1 245a, FFN 2 245b, FFN 3 245c, and FFN 4 245d), where each router 220, 225 independently routes each token 210, 215, respectively, based on a routing algorithm. The routing algorithm routes the tokens 210, 215 to maximize token-expert affinities. In one or more examples, the routing algorithm employs a token choice strategy (e.g., a top-k token routing strategy), where the routing algorithm selects the most suitable one (e.g., a top-one selection), two (e.g., a top-two selection), or several (e.g., k) experts to route to for each token. For example, the routing algorithm can choose the top-one or top-two experts with the highest affinity scores (e.g., highest probability (p)) for each token. The affinity scores can be trained together with the model parameters. In one or more examples, the affinity scores (e.g., probabilities) can be passed through a Softmax algorithm such that the affinity scores (e.g., probabilities), when summed together, are equal to one (1.0).

In FIG. 2, the router 220 routes (e.g., sends) token 210 to the second expert (e.g., FFN 2 240b) of a plurality of experts (e.g., FFN 1 240a, FFN 2 240b, FFN 3 240c, and FFN 4 240d), based on the router gate value 230 with a probability p equal to 0.65. The remaining experts (e.g., FFN 1 240a, FFN 3 240c, and FFN 4 240d) do not perform any processing. The router 225 routes (e.g., sends) the token 2 215 to the first expert (e.g., FFN 1 245a) of a plurality of experts (e.g., FFN 1 245a, FFN 2 245b, FFN 3 245c, and FFN 4 245d), based on the router gate value 235 with a probability p equal to 0.8. The remaining experts (e.g., FFN 2 245b, FFN 3 245c, and FFN 4 245d) do not perform any processing.

The sparse switch FFN layer 200 then returns the output of the selected FFN expert multiplied by a router gate value. The sparse switch FFN layer 200 illustrates an example of top-1 routing. For example, the sparse switch FFN layer 200 returns the output of the selected FFN expert (e.g., FFN 2 240b) multiplied (e.g., by multiplier 250) by the router gate value 230 with a probability p equal to 0.65. The sparse switch FFN layer 200 returns the output of the selected FFN expert (e.g., FFN 1 245a) multiplied (e.g., by multiplier 255) by the router gate value 235 with a probability p equal to 0.8.

MOE models may require a large amount of memory. For example, during on-device inference, all of the model parameters are loaded in random-access memory (RAM). For example, given an MOE architecture (e.g., Mixtral 8x7B), there needs to be enough RAM, such as video random-access memory (VRAM), to store a dense parameter model (e.g., a dense 47B parameter model, corresponding to 22 gigabytes (GB) in 4-bit).

Memory-constrained devices (e.g., mobile devices, XR devices, etc.) may not have enough RAM to be able to load all of the model parameters in RAM. Alternative solutions may be needed for memory-constrained devices, such as caching of the experts.

Caching may involve storing experts in memory, then loading a selected subset of experts from the memory into RAM for use. For example, a system may include memory (e.g., a flash memory) and RAM (e.g., a dynamic RAM (DRAM)). The attention weights may be loaded into RAM. A subset of the experts may be loaded into RAM at any given time. For example, a router may select which experts may be used to process a given token. The experts may be loaded into RAM and used to process the given token.

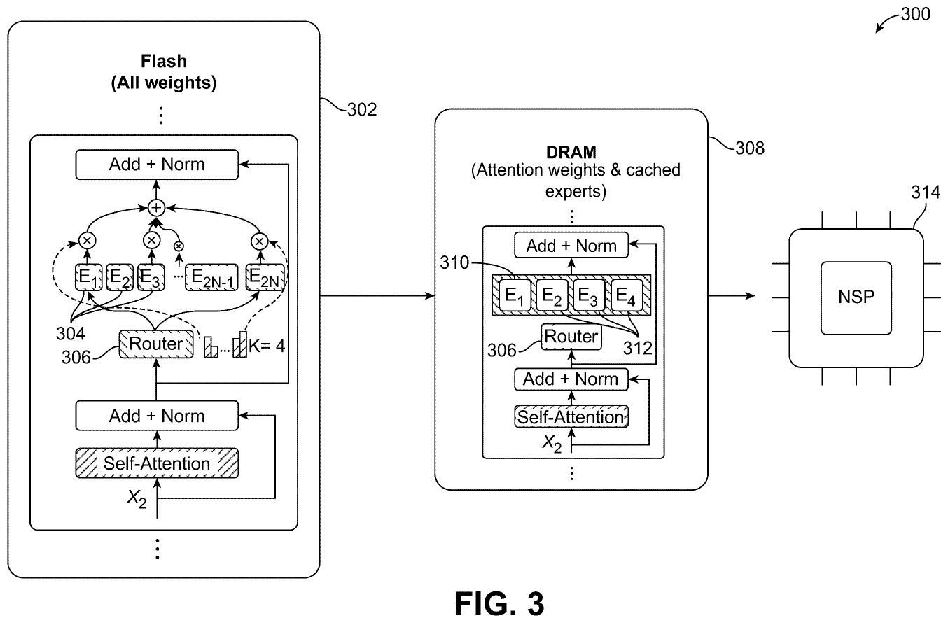

For example, FIG. 3 is a diagram illustrating an example system 300 including memory 302, a RAM 308, and a processor 314. System 300 may be a computing system of, for example, a smartphone, an XR device, a tablet computer, etc. System 300 may perform MOE techniques, according to various aspects of the present disclosure.

Memory 302 (also referred to as a first memory type) may be a memory (e.g., a main memory) of system 300. In some aspects, memory 302 may be a flash memory, a solid-state driver (SSD) memory, or a hard disk memory.

RAM 308 (also referred to as a second memory type) may be RAM of system 300. In some aspects, RAM 308 may be, or may include, dynamic RAM (DRAM), synchronous dynamic RAM (SDRAM) double-data-rate synchronous dynamic RAM (DDR SDRAM), video RAM (VRAM), etc.

Processor 314 may be, or may include, one or more processors of system 300. Processor 314 may be, or may include, a central processing unit (CPU), a graphics processing unit (GPU), a network signal unit (NSP), a neural processing unit (NPU), etc.

To implement an MOE model, system 300 may store experts 304 and router 306 at memory 302. In the present disclosure, references to “storing,” (and like terms) models (e.g., experts and/or routers) in a memory or a RAM may refer to storing all parameters (e.g., weights, biases, etc.) of the models in the referenced location.

Further, to use the MOE model (e.g., to use the MOE model to process a token), system 300 may load router 306 and a subset of experts 304 to RAM 308. For example, system 300 may load router 306 to RAM 308 and load a subset of experts 304 (e.g., experts 312) to a space 310 of RAM 308. In the present disclosure, references to “loading” (and like terms) models (e.g., experts and/or routers) to RAM may refer to transmitting parameters of the models from a memory to the RAM and storing the parameters in RAM such that the models are usable by a processor. For example, experts 312 may be stored in the space 310 of RAM 308 in such a way that experts 312 are usable by processor 314.

Further, to use the MOE model, processor 314 may access router 306 and experts 312 in RAM 308 to process tokens.

However, the lack of consistency in activation of experts in the temporal dimension can lead to a significant cache miss rate. For example, the router may select different experts from one token to the next. Loading and evicting experts from RAM may be computationally expensive (e.g., in terms of power, processing time, and/or bandwidth).

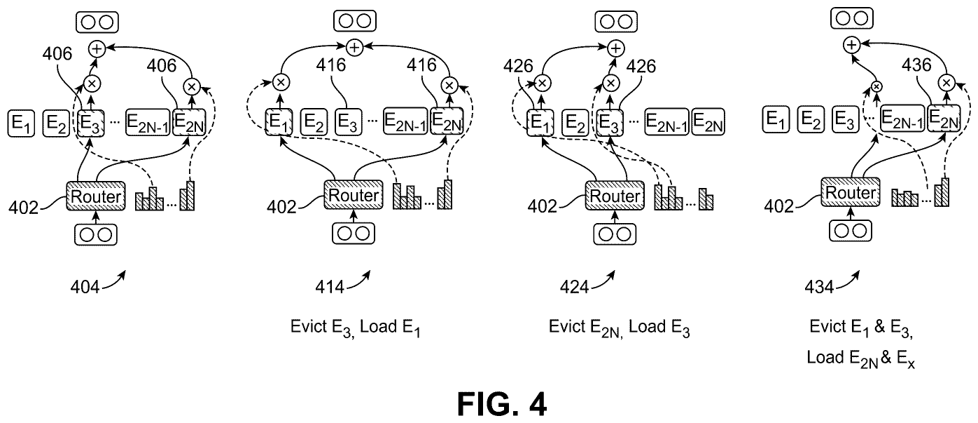

For example, FIG. 4 includes a block diagram illustrating an example process of selecting experts in response to an example string of tokens. For example, system 400 (which may be the same as, may be substantially similar to, and/or may perform the same, or substantially the same, operations as system 300 of FIG. 3) may be provided with input text “Qualcomm stands for Quality.” In this example, each of the words of the input text may be a token, and system 400 may provide each to router 402 (which may be the same as, may be substantially similar to, and/or may perform the same, or substantially the same, operations as router 306 of FIG. 3).

For token 404, router 402 may select experts 406 (e.g., E₃ and E_{2N}). Initially, there may be no experts loaded in cache. System 400 may load experts 406 (e.g., E₃ and E_{2N}) in cache and use experts 406 (e.g., E₃ and E_{2N}) to process token 404.

For token 414, router 402 may select experts 416 (e.g., E₁ and E_{2N}). Based on system 400 having loaded experts 406 (e.g., E₃ and E_{2N}) into cache to process token 404, experts 406 (e.g., E₃ and E_{2N}) may still be in cache. To process token 414, system 400 may evict E₃ from cache, maintain E_{2N} in cache, and load E₁ into cache. In the present disclosure, the terms “evict,” “unload,” “remove,” and like terms, may refer to removing a model (e.g., an expert) from cache. In some aspects, evicting a model from cache may include deleting parameters of the model from the cache. Additionally or alternatively, evicting a model from cache may refer to marking portions of memory as deleted and/or ready to be overwritten. Additionally or alternatively, evicting a model from cache may include writing over the parameters.

For token 424, router 402 may select experts 426 (e.g., E₁ and E₃). Based on system 400 having loaded experts 416 (e.g., E₁ and E_{2N}) into cache to process token 414, experts 416 (e.g., E₁ and E_{2N}) may still be in the cache. To process token 424, system 400 may evict E_{2N} from cache, maintain E₁ in cache, and load E₃ into cache.

For token 434, router 402 may select experts 436 (e.g., E_{2N} and Ex). Based on system 400 having loaded experts 426 (e.g., E₁ and E₃) into cache to process token 424, experts 426 (e.g., E₁ and E₃) may still be in the cache. To process token 434, system 400 may evict E₁ and E₃ from cache and load E_{2N} and Ex into cache.

FIG. 4 provides an example of top-2 caching in which two experts are selected, cached, and used to process each token. In other cases, other numbers of experts may be selected, cached, and used to process tokens.

Evicting and caching (e.g., loading into cache) tokens may be computationally expensive (e.g., in terms of power, processing time, and/or bandwidth). For example, each eviction and loading described with regard to FIG. 4 may be computationally expensive. It may be desirable to decrease eviction and loading operations.

The systems and techniques of the present disclosure may decrease evicting and caching operations by selecting experts based, at least in part, on experts that are already cached (which may be referred to as “cached experts”). In many cases, using a second expert other than the second expert selected by a router does not significantly impact the performance of processor of the tokens. For example, a router may provide a recommendation ranking experts relative to a given token. For instances, the router may determine a score indicating a predicted applicability of each expert of a number of experts to the given token. The recommendation from the router may indicate the score of each expert.

For example, a router may select a top k (e.g., top two) experts of eight total experts. Further, the router may determine scores or rankings of all eight experts. Using the top one expert and another expert may not significantly impact a perplexity of tokens processed by the model. Perplexity may refer to a measure of usefulness of tokens processed by an expert. For instance, a router may rank eight experts, the ranking may indicate which experts are recommended by the router to use to process a token. Using the top-ranked expert, and the third-ranked expert may result in about the same perplexity as using the top-ranked expert and the second-ranked expert.

Accordingly, the systems and techniques involve using, where possible, cached experts rather than loading unloaded experts. The systems and techniques may determine when to used cached experts rather than evicting cached experts and loading unloaded experts. This disclosure presents several example techniques that may be used to determine experts to use to process a token.

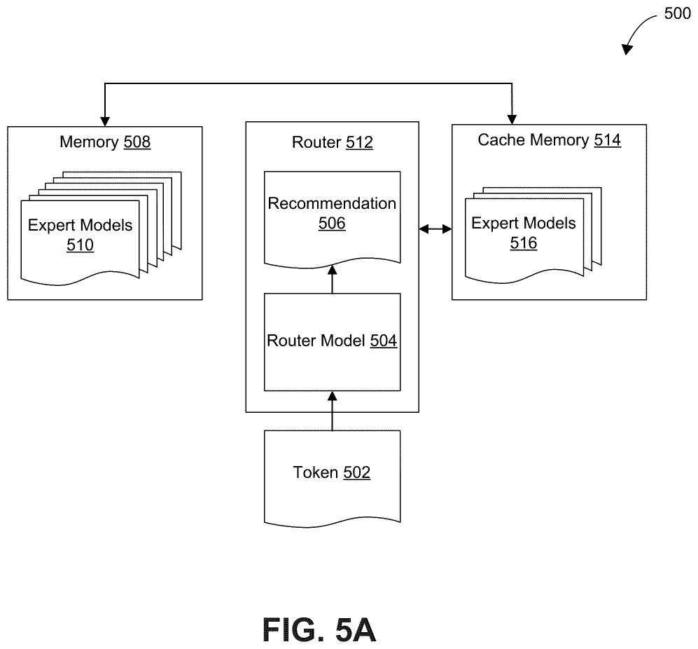

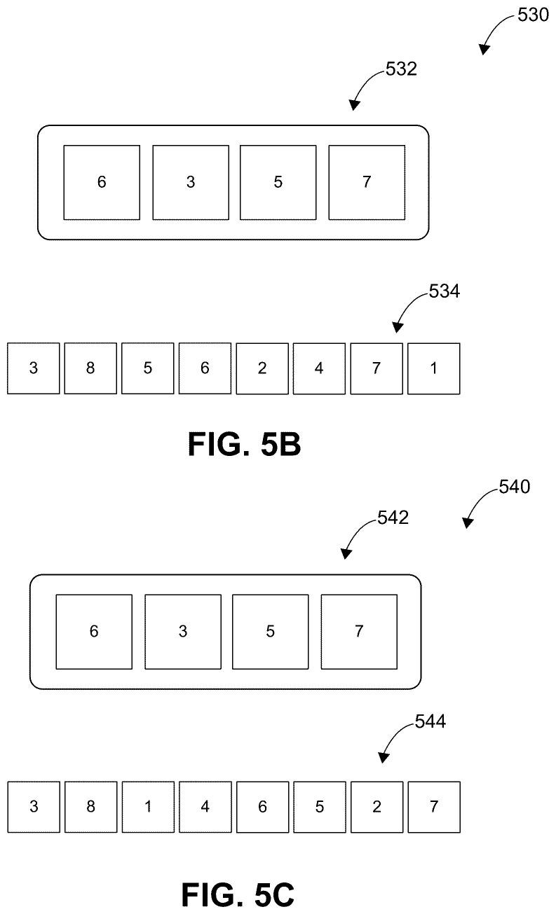

FIG. 5A is a block diagram illustrating an example system 500 for processing tokens, in accordance with aspects of the present disclosure. In general, a router model 504 may process a token 502 to generate a recommendation 506. Recommendation 506 may indicate a subset of expert models 510 (which may be stored in memory 508) to use to process token 502. A router 512 may determine which of expert models 510 to use to process token 502 based on recommendation 506 and based on cached expert models 516 (which may be cached in cache memory 514). In cases in which the determined expert models are not among cached expert models 516, cache memory 514 may cache the determined expert models.

FIG. 5B is a diagram illustrating an example scenario 530 in which the systems and techniques (e.g., router 512 of FIG. 5A) may determine experts based on a recommendation 534 of a router and based on cached experts 532, according to various aspects of the present disclosure. Similarly, FIG. 5C is a diagram illustrating an example scenario 540 in which the systems and techniques (e.g., router 512 of FIG. 5A) may determine experts based on a recommendation 544 of a router and based on cached experts 542, according to various aspects of the present disclosure. FIG. 5B and FIG. 5C provide examples scenarios to illustrate a “max-rank” technique for selecting experts. The max-rank technique may be implemented in a router, such as router 306 of FIG. 3.

The systems and techniques (e.g., router 512 of FIG. 5A) may implement a top-two expert selection. However, according to various aspects of the present disclosure, the systems and techniques, may retain in cache more experts than the number of experts selected for the prior token. For example, although in scenario 530 a top-two expert selection is used, cached experts 532 may include four experts. Retaining more experts than the number of experts selected for each token may allow the systems and techniques to skip evicting and caching experts in some scenarios.

For instance, a router may select and load experts 6 and 3 for a first token and select and load experts 5 and 7 for a second token. According to various aspects of the present disclosure, the systems and techniques (e.g., router 512 of FIG. 5A) may retain experts 6, 3, 5, and 7 in the cache. When the router receives the third token, if the third token includes any two of experts 6, 3, 5, and 7, the system need not evict or load any experts but use the cached experts.

Scenario 530 illustrates an example case in which a router provides a recommendation 534 based on an example token. Recommendation 534 incudes, in a ranked order, experts 3, 8, 5, 6, 2, 4, 7, and 1. According to various aspects of the present disclosure, the systems and techniques (e.g., router 512 of FIG. 5A) may determine to retain and use expert 3, based on expert 3 being the highest-ranked expert of recommendation 534. Additionally, the systems and techniques may determine to use expert 5, based on expert 5 being the top-ranked cached expert, even though expert 5 is not the second-ranked expert of recommendation 534. In this way, the systems and techniques may conserve computational resources by not evicting an expert to and loading expert 8.

In some aspects, the systems and techniques (e.g., router 512 of FIG. 5A) may determine to use a cached expert (or cached experts) instead of a recommended expert that is not cached based on the ranking of the cached experts. For example, the systems and techniques may determine to use a highest-ranked expert (or highest-ranked experts) from among the experts in the cache. Additionally, the systems and techniques may determine to use a highest-ranked expert (or highest ranked experts) from among the experts in the cache if the highest-ranked expert (or experts) exceed a ranking threshold. For example, the ranking threshold may be 4, so the systems and techniques may determine to use any expert ranked above 4th out of 8 total experts.

For example, if the ranking threshold were 4, in the case in which experts, 6, 3, 5, and 7, were cached experts 532, and recommendation 534 included, in a ranked order, experts 3, 8, 5, 6, 2, 4, 7, and 1, the systems and techniques (e.g., router 512 of FIG. 5A) may, according to a top-two determination, determine to use experts 3 and 5 to process a token. As an alternative example, if the ranking is 4, in the case in which experts, 6, 3, 5, and 7, were cached experts 542, and recommendation 544 included, in a ranked order, experts 3, 8, 1, 4, 6, 5, 2, and 7, the systems and techniques may, according to a top-two determination, determine to use cached expert 3, to unload a cached expert (e.g., one of experts 6, 5, or 7), and to load cached expert 8 because the cached experts do not include two experts recommended in the top-ranked 4 experts.

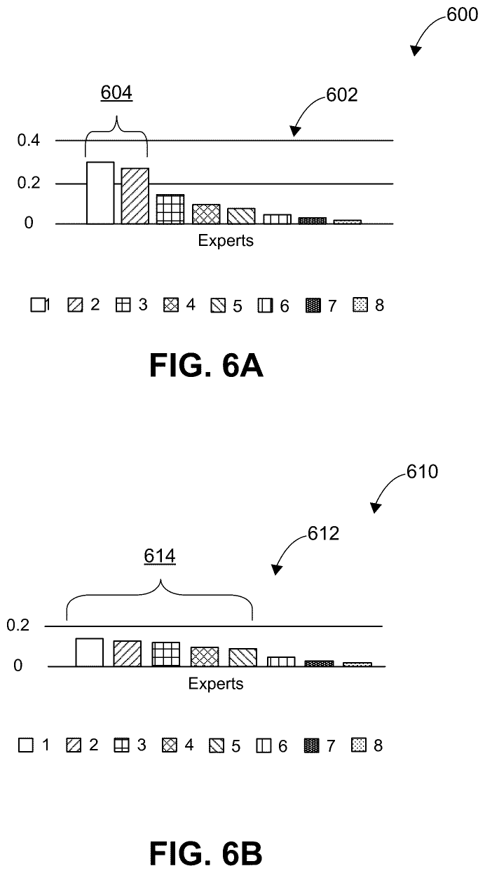

FIG. 6A is a diagram illustrating an example scenario 600 in which the systems and techniques (e.g., router 512 of FIG. 5A) may determine experts based on a recommendation 602 of a router and based on cached experts, according to various aspects of the present disclosure. Similarly, FIG. 6B is a diagram illustrating an example scenario 610 in which the systems and techniques may determine experts based on a recommendation 612 of a router and based on cached experts, according to various aspects of the present disclosure. FIG. 6A and FIG. 6B provide examples scenarios to illustrate a “probability-based” technique for selecting experts. The probability-based technique may be implemented in a router, such as router 306 of FIG. 3.

In some aspects, a router may determine a recommendation including scores or probabilities related to using experts to process a given token. For example, recommendation 602 illustrates a scenario 600 in which a router recommends using expert 1 with a score or probability of 0.32, expert 2 with a score or probability of 0.28, expert 3 with a score or probability of. 15, expert 4 with a score or probability of 0.1, expert 5 with a score or probability of 0.08, expert 6 with a score or probability of 0.04, expert 7 with a score or probability of 0.02, and expert 8 with a score or probability of 0.01. The systems and techniques (e.g., router 512 of FIG. 5A) may determine which experts to use based on the scores or probabilities of the various experts as found in recommendation 602. For example, the systems and techniques may determine, based on the recommendation 602 being very confident with regard to experts 1 and 2 and much less confident with regard to expert 3, to use experts 1 and 2 (e.g., regardless of which experts are cached).

In contrast, recommendation 612 illustrates a scenario 610 in which a router recommends using expert 1 with a score or probability of 0.19, expert 2 with a score or probability of 0.18, expert 3 with a score or probability of 0.17, expert 4 with a score or probability of 0.16, expert 5 with a score or probability of 0.15, expert 6 with a score or probability of 0.07, expert 7 with a score or probability of 0.05, and expert 8 with a score or probability of 0.03. The systems and techniques (e.g., router 512 of FIG. 5A) may determine which experts to use based on the scores or probabilities of the various experts as found in recommendation 612. For example, the systems and techniques may determine, based on the recommendation 612 having about the same confidence in each of experts 1, 2, 3, 4, and 5, to select expert 1 and any of experts 2, 3, 4, or 5, that are cached.

In order to determine when to use cached experts over recommended experts, the systems and techniques (e.g., router 512 of FIG. 5A) may sum scores or probabilities up to a threshold and determine that all experts that were summed to the threshold are probable experts. Then the systems and techniques may determine to use the top expert, plus one cached expert (or more in the case of a top-three or more selection) from among the probable experts.

For example, in scenario 600, experts 1 and 2 may sum to exceed the threshold for example, the threshold may be 0.55. Based on experts 1 and 2 exceeding the threshold, the systems and techniques (e.g., router 512 of FIG. 5A) may determine that experts 1 and 2 are probable experts 604. The systems and techniques may determine to use expert 1, the top-ranking expert, and expert 2, the only other expert in the probable experts.

In scenario 610, experts 1, 2, 3, 4, and 5 may sum to exceed the threshold for example, the threshold may be 0.80. Based on experts 1, 2, 3, 4, and 5 exceeding the threshold, the systems and techniques (e.g., router 512 of FIG. 5A) may determine that experts 1, 2, 3, 4, and 5 are probable experts 614. The systems and techniques may determine to use expert 1, the top-ranking expert. Additionally, the systems and techniques may determine to use the top-ranked expert from among experts 2, 3, 4, or 5 that are cached.

The threshold may be predetermined. In some cases, the threshold may be determined based on a conformal-prediction technique based on calibration data. For example, each expert of a group of experts may be used to process a number of sample tokens. Based on how each of the expert's process each of the sample tokens, a best expert for each sample token may be determined. Additionally, a router may be used to recommend experts for the sample tokens. The recommendations may be compared to the best experts.

For example, for a given sample token, a router may generate the recommendation:

$$P 1 = [ 0.5 , 0.22 , 0.18 , and 0.1 . ]$$

Which may include recommending expert 1 with a probability or score of 0.50, expert 2 with a probability or score of 0.22, expert 3 with a probability or score of 0.18, and expert 4 with a probability or score of 0.10. In fact, the best expert for the given sample token may be expert 3, which the router scored 0.18.

A score may be determined for the recommendation. The score may reflect the sum of all the probabilities from the highest to the best expert. For example, the score for recommendation PI may be 0.50+0.22+0.18=0.90.

A score may be determined for each sample token. Then, percentage quantiles may be calculated based on the scores. Intuitively, the quantile scores may provide information such as, a threshold that can be set to have a 90% chance of having the best expert in a group of probable experts.

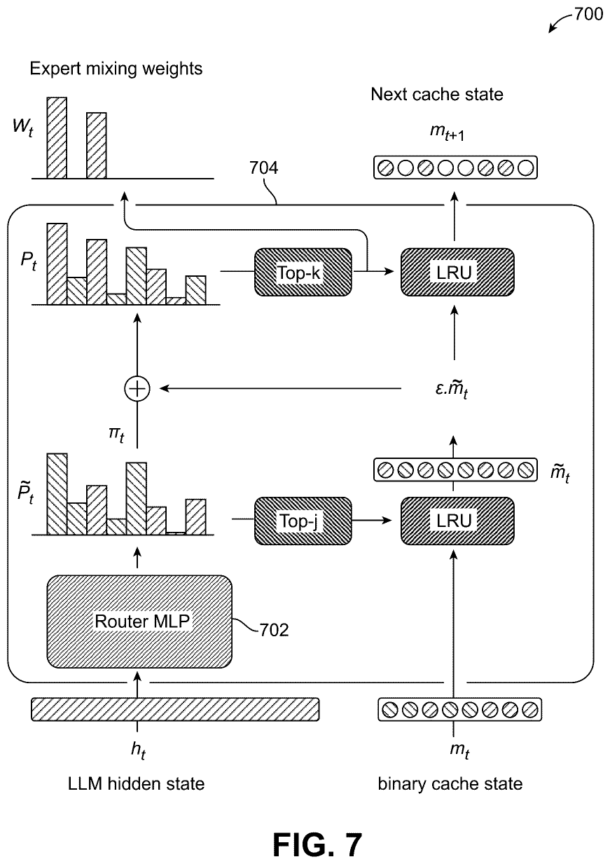

FIG. 7 is a diagram illustrating an example system 700 for determining experts based on a recommendation \tilde{p}ₜ of a router multi-layer perceptron (MLP) 702 and based on cached experts mₜ, according to various aspects of the present disclosure. System 700 illustrates a “cache-priors” technique for selecting experts. The cache-priors may be implemented in a router, such as router 306 of FIG. 3.

At a high level, system 700 manipulates router logits z^{l} to increase the probability of selecting experts that are already present in the cache. This manipulation occurs prior to the TopK(z′^{l}, k) operation, where z′^{l} represents the updated logits. Let the binary mask

$${m}_{t}^{l}$$

denote the state of the cache following the generation of the (t−1)-th token. System 700 may cause the top-j experts to be loaded into the cache if top-j experts are not already present, as the top-j experts significantly contribute to model performance. The updated cache state is denoted by

$${\tilde{m}}_{t}^{l} .$$

The updated logits are then computed as:

$${z}^{′ i} = {z}^{l} + λ \cdot {Δ}_{avg}^{l} \cdot {\tilde{m}}_{t}^{l}$$

where λ is a scaling factor that determines the influence of the cache state on the logits. Here, Δ_{avg} is defined as:

$${Δ}_{avg}^{l} = \frac{1}{t - 1} {\sum }_{{t}^{′} = 1}^{t - 1} ( max ( {z}_{{t}^{′}}^{l} ) - min ( {z}_{{t}^{′}}^{l} ) )$$

which represents the running average of the distance between the maximum and minimum logit values for all previous observed tokens.

In essence, system 700 may add a fraction of Δ_{avg} to the logits of experts that are already in the cache. Using Δ_{avg} is more effective than using the running average of maximum logit values. This is because routers in some MoE models, such as Qwen1.5-MoE-A2.7B, consistently generate negative logits, which can pose challenges when using the maximum logit as an additive bias term (e.g., when the maximum logit is 0). A major benefit of this method is that this method is training-free and data-free and can be applied to existing MoE models to improve their memory footprint for mobile-device deployment.

Described with reference to FIG. 7, cached experts mₜ represents initially cached experts. The initially cached experts may be experts cached based on processing a prior token. Cached experts mₜ is illustrated as a mask with green representing experts that are cached and light red representing experts that are not cached. For example, numbering the experts 1 to 8, experts 3, 6, 7, and 8 may be cached and experts 1, 2, 4, and 5 may not be cached.

A router MLP 702 (which may be the same as, may be substantially similar to, and/or may perform the same, or substantially the same, operations as router model 504 of FIG. 5A) of router 704 (which may be the same as, may be substantially similar to, and/or may perform the same, or substantially the same, operations as router 512 of FIG. 5A) may process a token to generate recommendation \tilde{p}ₜ. In some cases, router MLP 702 may not process an unprocessed token, but may process a token that has been processed by one or more layers of a router. For example, router MLP 702 may include a number of layers and may process a token sequentially through the number of layers. The processing of a token through a number of layers is represented by router MLP 702 processing hidden state hₜ to generate recommendation \tilde{p}ₜ.

Recommendation \tilde{p}ₜ illustrates the scores or probabilities of various experts as heights. For example, recommendation \tilde{p}ₜ may recommend, in order, experts, 1, 5, 3, 8, 2, 6, 4, and 7. Additionally, the color of recommendation \tilde{p}ₜ represents whether the experts are cached or not.

A “top-j” function of router 704 may provide an indication of the highest-ranked number (e.g., j) of experts of recommendation \tilde{p}ₜ. For example, top-j may provide an indication of a top-one (e.g., highest) ranked expert of recommendation \tilde{p}ₜ

The top-j function may provide the recommendation to a least-recently used (LRU) function of router 704. LRU may determine a least-recently-used expert from among cached experts mₜ. If the top-j expert is not among cached experts mₜ, LRU may remove the least-recently-used expert and cache the top-j expert to generate cached experts \tilde{m}ₜ. For example, in the example illustrated in FIG. 7, expert 1 may be the top-one expert provided by top-j to LRU. LRU may determine that expert 8 was the least-recently used from among cached experts mₜ. LRU may remove expert 8 and cache expert 1. For instance, experts 3, 6, and 7 may have been used to process a token more recently than expert 8 was used to process a token.

Router 704 may multiply cached experts \tilde{m}ₜ (which may be a binary mask) by a scaling factor ε. Scaling factor ε may be based on a running average of the distance between the maximum and minimum logit values for previously-observed tokens.

For instance, router 704 may keep a history of the max logit over time and take the mean of that. For example, scaling factor ε may be determined based on:

$$ε = {λΔ}_{avg}^{l} = \frac{λ}{t - 1} {\sum }_{{t}^{′} = 1}^{t - 1} ( max ( z \frac{l}{{t}^{′}} ) - min ( z \frac{l}{{t}^{′}} ) )$$

where λ is a hyperparameter and where N is the number of tokens processed to generate ε. Scaling factor ε determines how much preference is given cache reuse. For example, scaling factor ε controls the cache friendliness. If scaling factor ε is large, it causes router 704 to prefer reusing experts in cache. A small scaling factor ε may cause router 704 to keep using the original router output (recommendation \tilde{p}ₜ).

Router 704 may combine recommendation \tilde{p}ₜ (which may be alternatively referred to as πₜ) with the scaled expert mask— [symbol] . For example, recommendation pₜ represents \tilde{p}ₜ+ε·\tilde{m}ₜ. For example, expert 1 may be a highest-ranked expert based on expert 1 being a highest ranked expert of recommendation \tilde{p}ₜ and further based on expert 1 being cached by LRU based on expert 1 being the top-j expert. Expert 3 may be a second-highest ranked expert of recommendation \tilde{p}ₜ based on expert 3 being recommended by recommendation \tilde{p}ₜ and based on expert 3 being cached in cached experts \tilde{m}ₜ. Expert 3 may exceed expert 5 in recommendation \tilde{p}ₜ even though expert 5 is scored higher than expert 3 in recommendation \tilde{p}ₜ based on expert 5 being cached.

Router 704 may determine a top-k of the Softmax of the sum of πₜ and ε·\tilde{m}ₜ. For example, router 704 may determine:

$$Top - k ( Soft max ( π° + °ε {\tilde{m}}_{t} ) )$$

Router 704 may bias (e.g., adding an additional bias—ε) cached experts \tilde{m}ₜ in recommendation \tilde{p}ₜ. This may cause recommendation \tilde{p}ₜ to lean more towards recommending models that are in the cache (e.g., cached experts \tilde{m}ₜ).

If the top-k experts differ from the cached experts, LRU may remove a least-recently-used expert and cache one or more of the top-k experts. The LRU may output \tilde{m}ₜ₊₁ which represents state of cached experts.

Additionally, router 704 may determine mixing weights [symbol] that may indicate how experts 1 and 3 are to be weighted for use. For example, a downstream user may use experts 1 and 3 based on \tilde{m}ₜ₊₁. Further the downstream user may put more weight on the output of expert 1 than on the output of expert 3 based on weights [symbol] .

System 700 may receive as input a cache state for the current layer for the previous tokens (e.g., cached experts \tilde{m}ₜ). Router 704 may multiply the cached-experts mask (e.g., cached experts \tilde{m}ₜ) by a value (e.g., scaling factor ε) and then add it to the logits of the router output (e.g., recommendation \tilde{p}ₜ). This increases the probability of router 704 selecting experts that are already in the cache.

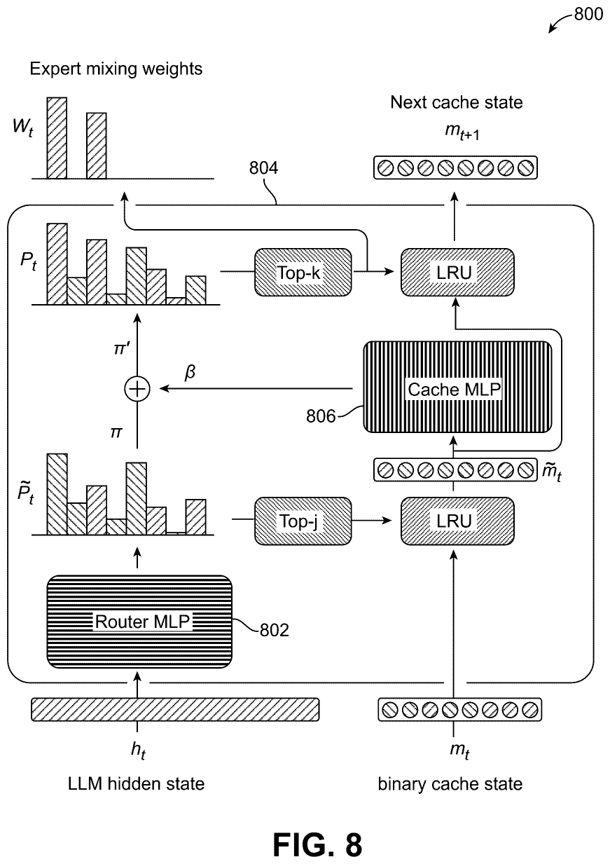

FIG. 8 is a diagram illustrating an example system 800 for determine experts based on a recommendation \tilde{p}ₜ of a router MLP 802 and based on cached experts mₜ, according to various aspects of the present disclosure. System 800 illustrates a “cache MLP” technique for selecting experts. The cache MLP may be implemented in a router, such as router 306 of FIG. 3.

A limitation of the training-free cache prior method (e.g., described with regard to FIG. 7) is that it uses a single hyperparameter, λ, uniformly across all experts in all layers. The training-free cache prior method does not consider the uncertainty in the router's expert selection, or the specific token being processed. To address these limitations, system 800 of FIG. 8 includes a caching MLP router, denoted as

$${G}_{cache}^{l} ( {x}_{t} , {\tilde{m}}_{t}^{l} ; Φ ) ,$$

which learns to manipulate the logits of individual experts in an input-dependent manner.

The Caching MLP Router acts as an auxiliary routing mechanism designed to enhance the selection probability of experts already in the cache. The Caching MLP Router enhances the selection probability of experts already in the cache by conditioning decisions of the Caching MLP Router on both the current cache state and the input token. This allows for a more nuanced and adaptive manipulation of logits, tailored to each expert and layer.

Formally, let xₜ represent the input token at time t and

$${m}_{t}^{l}$$

denote the current state of the cache for layer l. The Caching MLP Router computes an adjustment term for each expert's logit as follows:

$$Δ {z}_{i}^{l} = {G}_{cache}^{l} ( {x}_{t} , {\tilde{m}}_{t}^{l} ; Φ )$$

where

$$Δ {z}_{i}^{l}$$

is the adjustment to the logit for expert Eᵢ^{l}. The updated logits are then given by:

$${z}_{l}^{′ l} = {z}_{i}^{l} + Δ {z}_{i}^{l}$$

This framework allows the model to dynamically adjust expert selection based on the current input token and cache conditions, promoting efficient use of cached resources. FIG. 8 provides an overview of this designed framework.

To enhance the cache-hit rate of MoEs using the caching MLP router, system 800 implements a two strategies for loss functions. According to the first strategy, system 800 applies a dual-loss approach that penalizes the selection of experts not present in the cache while simultaneously promoting the selection of alternative experts that are already cached. According to the second strategy, system 800 utilizes a differentiable sorting loss to optimize expert selection with respect to cache availability.

For example, system 800 may implement a cache-aware routing with dual-loss optimization. For example, let

$$TopK ( {z}_{i}^{′ l} )$$

denote the set of indices for the top-k experts selected based on the updated logits

$${z}_{i}^{′ l} ,$$

and let C^{l} be the set of indices for experts currently in the cache. The set of top-k experts not in the cache may be defined as

$${S}_{out} = \{ i \vert i ∈ TopK ( {z}_{i}^{′ l} ) and i ∉ {C}^{l} \} .$$

Similarly, the set of cached experts not selected in the top-k may be defined as

$${S}_{i n} = \{ i \vert i ∈ {C}^{l} and i ∉ TopK ( {z}_{i}^{′ l} ) \} .$$

The first loss term penalizes the selection of top-k experts that are not in the cache. To achieve this, system 800 applies a Softmax function to obtain normalized selection probabilities

$${p}_{i}^{l} = σ ( {z}_{i}^{′ l} )$$

and compute:

$${ℒ}_{out}^{l} = {\sum }_{i ∈ {S}_{out}} {p}_{i}^{l}$$

To promote the selection of experts that are in the cache but not within the top-k, system 800 may apply the following loss:

$${ℒ}_{i n}^{l} = - {\sum }_{i ∈ {S}_{i n}} {p}_{i}^{l}$$

Aggregated across all layers L, the total loss to enhance cache-aware routing can be expressed as:

$${ℒ}_{cache} = \frac{1}{L} {\sum }_{l = 1}^{L} ( {λ}_{1} {L}_{out}^{l} + {λ}_{2} {L}_{i n}^{l} )$$

where λ₁ and λ₂ are the coefficients that control the strength of the two loss terms.

Additionally or alternatively, system 800 may implement a ranking loss. In the ideal scenario, the objective is to maximize the intersection between the set of predicted top-k experts and the set of experts present in the cache, without prioritizing specific weights among the top-k experts. This focus on ranking rather than precise weight values can be achieved using a differentiable sorting loss. In differentiable ranking, we derive a permutation matrix P∈ [symbol] ^{N×N} from the logits

$${z}_{i}^{′ l} :$$

$$P = diffsort ( {z}_{i}^{′ l} , r )$$

Here, each element P_{i,j} represents the probability that expert i has rank j when sorted. While this matrix should ideally be binary, a temperature parameter τ is introduced for differentiability. Since our interest lies solely in identifying the top-k experts, we truncate P after the k-th row. To disregard the ordering within the top-k experts, we sum across these rows to obtain a selection vector

$${s}_{i} = {\sum }_{j = 0}^{k} {P}_{ij} .$$

Each element sᵢ reflects the probability that expert i is among the top-k experts. For the final cache loss, we compute the [symbol] ₁ loss between this selection vector s and a binary cache mask m, which indicates whether each expert is in the cache:

$${ℒ}_{cache} = \frac{1}{L} {\sum }_{i = 1}^{L} {‖ {s}^{l} - {m}^{l} ‖}_{1}$$

Described with reference to FIG. 8, system 800 is similar to system 700 of FIG. 7. However, whereas router 704 of FIG. 7 multiplies the mask experts \tilde{m}ₜ by scaling factor ε, system 800 includes cache MLP 806 that may determine scaled experts β based on experts \tilde{m}ₜ.

Cached experts mₜ, of FIG. 8 may be the same as, or may be substantially similar to, cached experts mₜ, of FIG. 7. Router MLP 802 may be the same as, may be substantially similar to, and/or may perform the same, or substantially the same, operations as router MLP 702 of FIG. 7. Recommendation \tilde{p}ₜ of FIG. 8 may be the same as, or may be substantially similar to, recommendation \tilde{p}ₜ of FIG. 7. The top-j function of FIG. 8 may be the same as, may be substantially similar to, and/or may perform the same, or substantially the same, operations as the top-j function of FIG. 7. The LRU of FIG. 8 may be the same as, may be substantially similar to, and/or may perform the same, or substantially the same, operations as the LRU of FIG. 7. Experts \tilde{m}ₜ. of FIG. 8 may be the same as, or may be substantially similar to, experts \tilde{m}ₜ. of FIG. 7.

Cache MLP 806 may be, or may include, a machine-learning model (e.g., an MLP) trained to generate scaled experts based on an expert mask. Cache MLP 806 may generate scaled experts β based on experts \tilde{m}ₜ. Cache MLP 806 may learn to minimally change routing decisions while increasing cache hit rate. Cache MLP 806 may be conditioned on the LRU cache state and, in some cases, router logits. In the present disclosure, the term “logit” may refer to an output of a neural network layer before the activation function is applied.

In the “cache-priors” technique described with regard to FIG. 7, router 704 adds the mask (e.g., experts \tilde{m}ₜ.) multiplied by a coefficient (e.g., scaling factor ε) to outputs the router (recommendation \tilde{p}ₜ). Cache MLP 806 is trained to determine a better way to adjust the outputs the router (recommendation \tilde{p}ₜ) based on the mask (e.g., experts \tilde{m}ₜ).

Router 804 combines scaled experts β with recommendation π to generate π′ (which may be alternatively referred to as recommendation pₜ). For example, expert 1 may be a highest-ranked expert based on expert 1 being a highest ranked expert of recommendation \tilde{p}ₜ and further based on expert 1 being cached by LRU based on expert 1 being the top-j expert. Expert 3 may be a second-highest ranked expert of recommendation pₜ based on expert 3 being recommended by recommendation \tilde{p}ₜ and based on expert 3 being cached in experts \tilde{m}ₜ. Expert 3 may exceed expert 5 in recommendation pₜ even though expert 5 is scored higher than expert 3 in recommendation \tilde{p}ₜ based on expert 5 being cached.

Router 804 includes a top-k operation which may be an indicator function. However, if router 804 applies soft max on this π′ and weighs the experts, it performs poorly. For example, the models (e.g., the experts and the routers) are trained by joint manufacturers and adjusting parameters and how they are used can affect their performance. Changing the Softmax in this way—reweighting the experts with the updated value affects the performance of router 804. For example, if router 804 were to use the soft max of π′, it hurts the performance. For example, it loses its original performance of downstream tasks, like its generalized ability is lost. For example, we may not have Chinese data to learn this logit and it suddenly loses its ability to handle Chinese language.

So router 804 reuses the original expert weighting mix w that was generated based on the original router probabilities and changes the selection mechanism. The selection mechanism is essentially Top-K applied to π′.

Each of the experts that are chosen through an indicator function usually get a weighting assigned to them as well. For example, we say 70% weight to expert number 1, 30% weight to expert number 2. So this is commonly what is done, and the rest of the experts get zero weight because the rest of the experts are not chosen. So, and this weight is coming from a soft max applied to the original router probability.

So router 804 reuses the original expert weighting mix w, but then it causes a problem because this indicator function or Top-K operation is by nature not differentiable because top-k provides a discrete option (e.g, is a given expert included, or not). For that there are tricks, for example, Gumbel-Top-K Trick, or differentiable sorting operation. These may be used to make this differentiable, and this way router 804 still performs well.

Router 804 may determine a top-k of the Softmax of the sum of π and β. For example, router 804 may determine:

$$β = {MLP}_{cache} ( π , {\tilde{m}}_{t} ) \to {π}^{′} = π + β$$

The top-k function of FIG. 8 may be the same as, may be substantially similar to, and/or may perform the same, or substantially the same, operations as the top-k function of FIG. 7. The top-k operation may be performed on the transformed logits

$${l}_{i} = l ( \vert \{ j ∈ \{ N \} : {π}_{j}^{′} \geq {π}_{i}^{′} \} \vert \leq K )$$

$$y = {\sum }_{i = 1}^{N} {l}_{i} {w}_{i} \cdot {E}_{i} ( h )$$

where lᵢ may be determined according to the Gumbel Top-k Trick described by Kool, Wouter, Herke Van Hoof, and Max Welling. “The Gumbel-top-k trick for sampling sequences without replacement.” ICML, 2019 or Differentiable sorting as described by Petersen, Felix, et al. “Monotonic differentiable sorting networks.” ICLR 2022.

The LRU of FIG. 8 may be the same as, may be substantially similar to, and/or may perform the same, or substantially the same, operations as the LRU of FIG. 7.

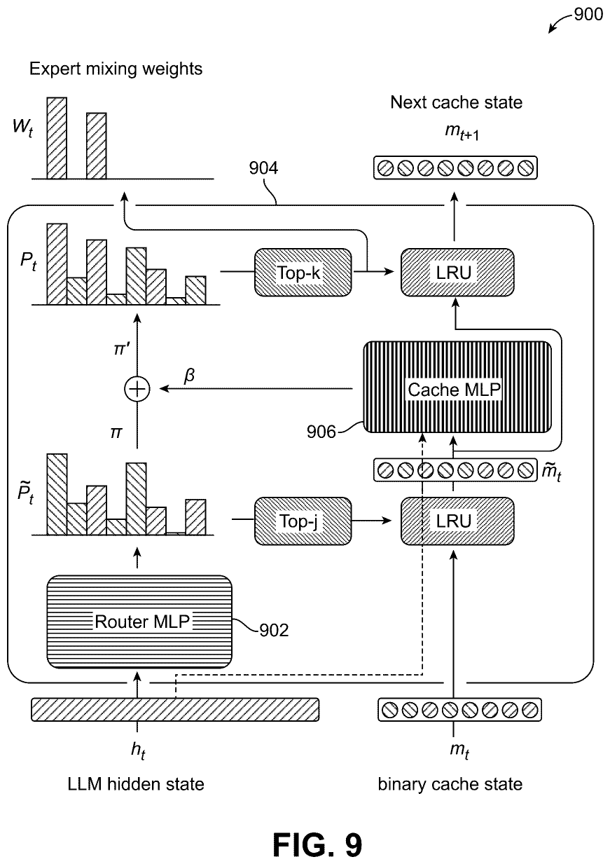

FIG. 9 is a diagram illustrating an example system 900 for determine experts based on a recommendation \tilde{p}ₜ of a router MLP 902 and based on cached experts mₜ, according to various aspects of the present disclosure. System 900 illustrates an alternative “cache MLP” technique for selecting experts. The alternative cache MLP may be implemented in a router, such as router 306 of FIG. 3.

System 900 may be the same as, may be substantially similar to, and/or may perform the same, or substantially the same, operations as system 800 of FIG. 8. Additionally, cache MLP 906 may be trained to generate scaled experts β based on inputs to router MLP 902 (e.g., based on hidden states output by a prior layer of the router). Providing the hidden state hₜ of tokens as input to cache MLP 906 can further enhance the trade-off between improved cache hit-rate and downstream task performance. System 900 may be more powerful that system 800, particularly for minimal finetuning of the MoE on downstream tasks.

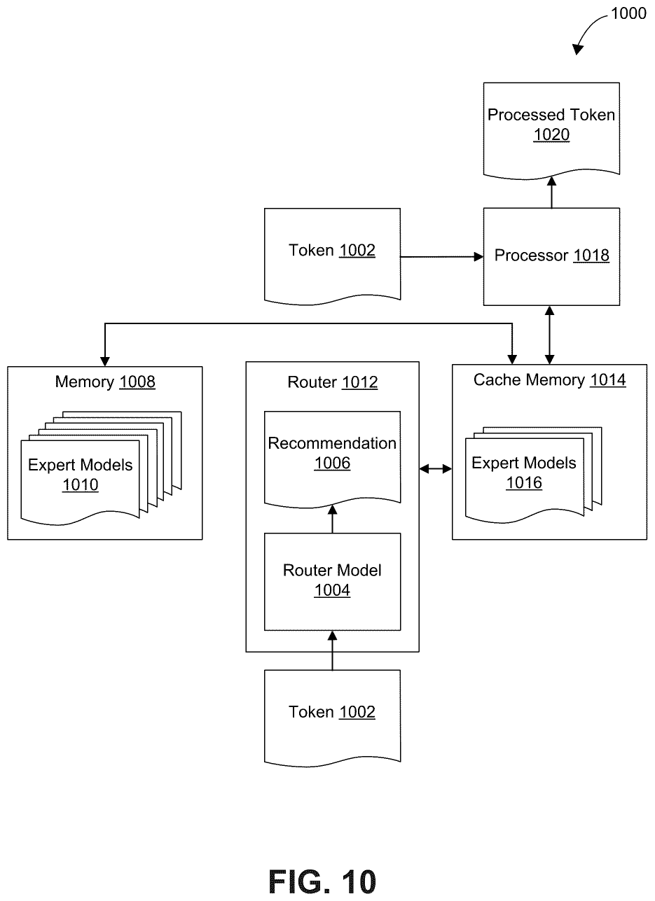

FIG. 10 is a block diagram illustrating an example system 1000 for processing tokens, in accordance with aspects of the present disclosure. In general, a router model 1004 may process a token 1002 to generate a recommendation 1006. Recommendation 1006 may indicate a subset of expert models 1010 (which may be stored in memory 1008) to use to process token 1002. A router 1012 may determine which of expert models 1010 to use to process token 1002 based on recommendation 1006 and based on cached expert models 1016 (which may be cached in cache memory 1014). In cases in which the determined expert models are not among cached expert models 1016, cache memory 1014 may cache the determined expert models. Once, cache memory 1014 has the determined expert models cached, processor 1018 may process token 1002 to generate processed token 1020 using the determined expert models. Router 1012 may be the same as, may be substantially similar to, and/or may perform the same, or substantially the same, operations as router 512 of FIG. 5A. Additionally or alternatively, router 1012 may be the same as, may be substantially similar to, and/or may perform the same, or substantially the same, operations as router 704 of FIG. 7, router 804 of FIG. 8, and/or router 904 of FIG. 9.

Token 1002 may the same as, or may be substantially similar to, token 120a, token 120b, token 125a, or token 125b of FIG. 1, token 210 or token 215 of FIG. 2, token 404, token 414, token 424, or token 434 of FIG. 4, hₜ of FIG. 7, hₜ of FIG. 8, and/or hₜ of FIG. 9. Router model 1004 may be the same as, may be substantially similar to, and/or may perform the same, or substantially the same, operations as router 220 or router 225 of FIG. 2, router 306 of FIG. 3, router 402 of FIG. 4, router MLP 702 of FIG. 7, router MLP 802 of FIG. 8, and/or router MLP 902 of FIG. 9.

Router model 1004 may be a machine-learning model trained to determine experts to use to process tokens. In some aspects, router model 1004 may be trained with expert models 1010, for example, in an end-to-end training process. Recommendation 1006 may be the same as, or may be substantially similar to, recommendation 534 of FIG. 5B, recommendation 544 of FIG. 5C, recommendation 602 of FIG. 6A, recommendation 612 of FIG. 6B, \tilde{p}ₜ of FIG. 7, \tilde{p}ₜ of FIG. 8, and/or \tilde{p}ₜ of FIG. 9.

Memory 1008 may be the same as, may be substantially similar to, and/or may perform the same, or substantially the same, operations as memory 302 of FIG. 3. Expert models 1010 may be the same as, may be substantially similar to, and/or may perform the same, or substantially the same, operations as experts 304 of FIG. 3.

Router 1012 may be the same as, may be substantially similar to, and/or may perform the same, or substantially the same, operations as router 306 of FIG. 3, router 704 of FIG. 7, router 804 of FIG. 8, and/or router 904 of FIG. 9. Router 1012 may implement any of the techniques described herein for determining experts. For example, router 1012 may determine experts based on a ranking of experts (e.g., as described with regard to FIG. 5B and FIG. 5C). As another example, router 1012 may determine experts based on probabilities or scores (e.g, as described with regard to FIG. 6A and FIG. 6B). As another example, router 1012 may determine experts by biasing cached experts (e.g., as described with regard to FIG. 7, FIG. 8, and/or FIG. 9).

Cache memory 1014 may be the same as, may be substantially similar to, and/or may perform the same, or substantially the same, operations as RAM 308 of FIG. 3. Cached expert models 1016 may be the same as, may be substantially similar to, and/or may perform the same, or substantially the same, operations as experts 312 of FIG. 3. Processor 1018 may be the same as, may be substantially similar to, and/or may perform the same, or substantially the same, operations as processor 314 of FIG. 3.

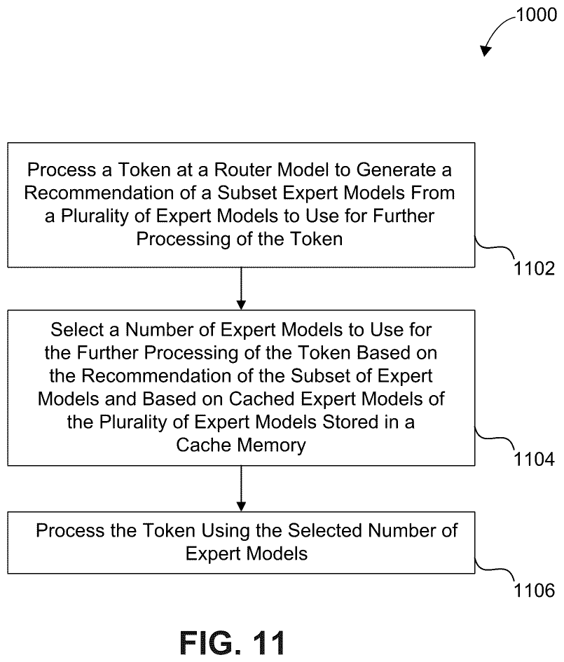

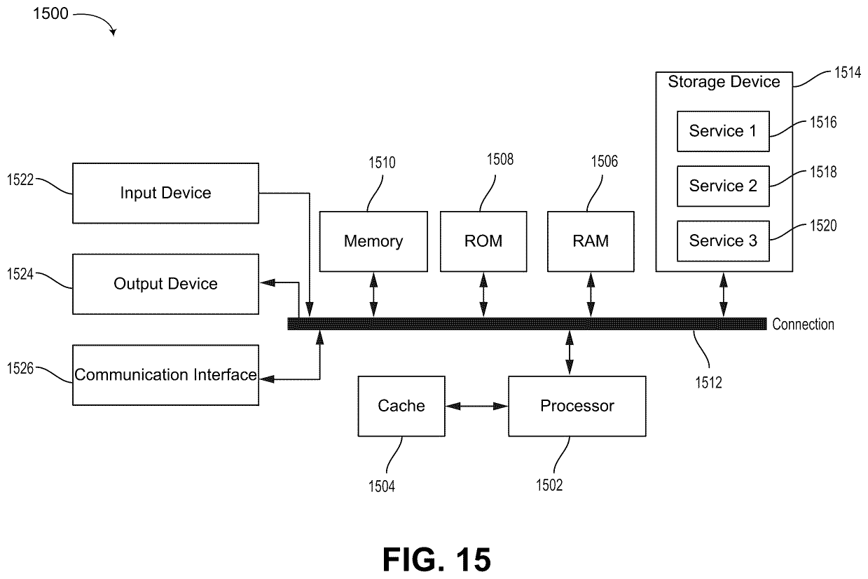

FIG. 11 is a flow diagram illustrating an example process 1100 for processing tokens, in accordance with aspects of the present disclosure. One or more operations of process 1100 may be performed by a computing device (or apparatus) or a component (e.g., one or more chipsets, one or more processors such as one or more CPUs, DSPs, NPUs, neural signal processors (NSPs), microcontrollers, application specific integrated circuits (ASICs), field programmable logic arrays (FPGAs), programmable logic devices, discrete gates or transistor logic components, discrete hardware components, etc., an ML system such as a neural network model, any combination thereof, and/or other component or system) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the one or more operations of process 1100. The one or more operations of process 1100 may be implemented as software components that are executed and run on one or more processors. In some examples, as noted previously, the methods described herein (e.g., process 1100 of FIG. 11, and/or other methods described herein) can be performed, in whole or in part, by a computing device or apparatus. In one example, one or more of the methods can be performed by system 300 of FIG. 3, system 700 of FIG. 7, system 800 of FIG. 8, system 900 of FIG. 9, system 1000 of FIG. 10, or by another system or device. In another example, one or more of the methods (e.g., process 1100, and/or other methods described herein) can be performed, in whole or in part, by the computing-device architecture 1500 shown in FIG. 15. For instance, a computing device with the computing-device architecture 1500 shown in FIG. 15 can include, or be included in, the components of the system 300, system 700, system 800, system 900, and/or system 1000 and can implement the operations of process 1100, and/or other process described herein.

At block 1102, a computing device (or one or more components thereof) may process a token at a router model to generate a recommendation a subset of expert models from a plurality of expert models to use for further processing of the token. For example, router model 1004 may process token 1002 to generate recommendation 1006 of a subset of expert models 1010 to use to further process token 1002.

At block 1104, the computing device (or one or more components thereof) may select a number of expert models to use for the further processing of the token based on the recommendation of the subset of expert models and based on cached expert models of the plurality of expert models stored in a cache memory. For example, router 1012 may determine a number of expert models based on recommendation 1006 and based on cached expert models 1016 (which are cached in cache memory 1014).

In some aspects, the cached expert models may be loaded into the cache memory to process a previous token. For example, cached expert models 1016 may be loaded into cache memory 1014 based on a determination to load cached expert models 1016 into cache memory 1014 to process a previous token.

In some aspects, the computing device (and/or one or more component thereof) may remove a first expert model of the cached expert models from the cache memory based on the first expert model not being among the selected number of expert models; and load a second expert model of the plurality of expert models from a memory into the cache memory based on the second expert model being among the selected number of expert models. For example, based on the experts determined by router 1012 at block 1104, system 1000 may remove one of cached expert models 1016 from cache memory 1014 and cache one of expert models 1010 (e.g., to replace the removed one of cached expert models 1016).

In some aspects, the recommendation may be, or may include, a respective expert-model rank of each expert model of the plurality of expert models. The computing device (and/or one or more component thereof) may select the number of expert models (e.g., at block 1104) based on the respective expert-model rank of each expert model of the plurality of expert models. For example, router 1012 may determine the expert models to use to process token 1002 based on expert-model ranks included in recommendation 1006 (e.g., as described with regard to FIG. 5B and FIG. 5C).

In some aspects, the computing device (and/or one or more component thereof) may select a highest-ranked expert model of the plurality of expert models to be among the selected number of expert models. For example, router 1012 may select a highest-ranked expert model recommended by cached expert models 1016 (e.g., regardless of whether the highest-ranked expert model is among cached expert models 1016).

In some aspects, the computing device (and/or one or more component thereof) may select an expert model from among the cached expert models to be among the selected number of expert models based on an expert-model rank of the expert model exceeding a ranking threshold. For example, router 1012 may determine an expert model to use to process token 1002 from among cached expert models 1016 (e.g., even though the determined expert model is not a highest or second-highest-ranking expert model, for example, as described with regard to FIG. 5B).

In some aspects, the computing device (and/or one or more component thereof) may, based on expert-model ranks of the cached expert models not exceeding a ranking threshold, select the number of expert models from among expert models not loaded into the cache memory. For example, router 1012 may determine an expert model to use to process token 1002 from among cached expert models 1010 (e.g., based on none of cached expert models 1016 exceeding the raking threshold, for example, as described with regard to FIG. 5C).

In some aspects, the recommendation may be, or may include, a respective probability of each expert model of the plurality of expert models. The computing device (and/or one or more component thereof) may select the number of expert models (e.g., at block 1104) based on the respective probability of each expert model of the plurality of expert models. For example, router 1012 may select expert models to use to process token 1002 based on probabilities or scores included in recommendation 1006 (e.g., as described with regard to FIG. 6A and FIG. 6B).

In some aspects, the computing device (and/or one or more component thereof) may identify probable expert models from among the plurality of expert models based on a sum of probabilities associated with the probable expert models exceeding a probability threshold; and select an expert model from among the cached expert models to be among the selected number of expert models based on the expert model being among the probable expert models. For example, router 1012 may determine probable expert models (e.g., probable experts 604 or probable experts 614) based on a sum of probabilities of the probable expert models exceeding a probability threshold (e.g., as described with regard to FIG. 6A and FIG. 6B). Having identified the probable expert models, router 1012 may select one or more probable expert models from among cached expert models 1016.

In some aspects, the computing device (and/or one or more component thereof) may identify probable expert models from among the plurality of expert models based on a sum of probabilities associated with the probable expert models exceeding a probability threshold; and based on the cached expert models not being among the probable expert models, select the number of expert models from among expert models not loaded into the cache memory. For example, router 1012 may determine probable expert models (e.g., probable experts 604 or probable experts 614) based on a sum of probabilities of the probable expert models exceeding a probability threshold (e.g., as described with regard to FIG. 6A and FIG. 6B). Having identified the probable expert models, router 1012 may determine whether cached expert models 1016 includes any probable expert models. Based on cached expert models 1016 not including any probable expert models, router 1012 may determine to cache one or more probable expert models from among expert models 1010 to process token 1002.

In some aspects, the recommendation may be, or may include, a respective output value of each expert model of the plurality of expert models. The computing device (and/or one or more component thereof) may select the number of expert models based on the output values of the plurality of expert models and output values of the cached expert models. For example, router 1012 may select the expert models (e.g., at block 1104) based on output values (e.g., \tilde{p}ₜ) and cached expert models 1016 (e.g., as described with regard to FIG. 7, FIG. 8, and/or FIG. 9).

In some aspects, the computing device (and/or one or more component thereof) may select a highest-valued expert model of the plurality of expert models to be among the selected number of expert models. For example, router 1012 may select a highest-valued expert model from among the expert models recommended by recommendation 1006. The highest-valued expert models may be highest-valued based on the output values (e.g., \tilde{p}ₜ) and the cached expert models 1016 (e.g., as described with regard to FIG. 7, FIG. 8, and/or FIG. 9).

In some aspects, the computing device (and/or one or more component thereof) may increase biasing the output values of the cached expert models for selecting the number of expert models. For example, router 1012 may bias output values (e.g., \tilde{p}ₜ) of cached expert models 1016 when determining experts (e.g., at block 1104) (e.g., as described with regard to FIG. 7, FIG. 8, and/or FIG. 9).

In some aspects, the output values of the cached expert models are biased by a predetermined amount. For example, router 1012 may bias the output values of cached expert models 1016 by a predetermined amount (e.g., as describe with regard to FIG. 7).

In some aspects, the computing device (and/or one or more component thereof) may process the output values of the plurality of expert models and a mask indicative of the cached expert models using a machine-learning model to generate biasing values; and bias the output values of the cached expert models according to the biasing values for selecting the number of expert models. For example, router 804 may process \tilde{p}ₜ and a mask indicative of cached expert models 1016 at cache MLP 806 to generate β (e.g., as described with regard to FIG. 8). Router 804 may bias \tilde{p}ₜ based on β.

In some aspects, the computing device (and/or one or more component thereof) may process router input values using the machine-learning model to generate the biasing values. For example, in addition to processing \tilde{p}ₜ and the mask indicative of cached expert models 1016, cache MLP 906 may process hₜ to generate β (e.g., as described with regard to FIG. 9).

At block 1106, the computing device (or one or more components thereof) may process the token using the selected number of expert models. For example, processor 1018 may process token 1002 using the expert models determined by router 1012 at block 1104.

In some aspects, the computing device (and/or one or more component thereof) may remove a first expert model of the cached expert models from the cache memory based on the first expert model not being among the selected number of expert models; and load a second expert model of the plurality of expert models from a memory into the cache memory based on the second expert model being among the selected number of expert models. For example, based on the experts determined by router 1012 at block 1104, system 1000 may remove one of cached expert models 1016 from cache memory 1014 and cache one of expert models 1010 (e.g., to replace the removed one of cached expert models 1016).

In some aspects, the computing device (and/or one or more component thereof) may process the token using the selected number of expert models based on the selected number of expert models being among the cached expert models. For example, based on router 1012 determining that cached expert models 1016 include the experts determined at block 1104, processor 1018 may process token 1002 using cached expert models 1016 (e.g., without removing and loading any of expert models 1010).

In some examples, the processes described herein (e.g., process 1100 and/or other process described herein) may be performed by a computing device or apparatus or a component or system (e.g., one or more chipsets, one or more processors such as one or more central processing units (CPUs), digital signal processors (DSPs), neural processing units (NPUs), network signal processors (NSPs), microcontrollers, application-specific integrated circuits (ASICs), field-programmable gate arrays (FPGAs), programmable logic devices, discrete gates or transistor logic components, discrete hardware components, etc., an machine-learning (ML) system such as a neural network model, any combination thereof, and/or other component or system) of the computing device or apparatus. The computing device or apparatus may be a vehicle or component or system of a vehicle, a mobile device (e.g., a mobile phone), a network-connected wearable such as a watch, an extended reality (XR) device (e.g., a virtual reality (VR) device, augmented reality (AR) device, and/or mixed reality (MR) device), or other type of computing device.

In some examples, as noted previously, the methods described herein (e.g., process 1100 of FIG. 11, and/or other methods described herein) can be performed, in whole or in part, by a computing device or apparatus. In one example, one or more of the methods can be performed by system 300 of FIG. 3, system 700 of FIG. 7, system 800 of FIG. 8, system 900 of FIG. 9, system 1000 of FIG. 10, or by another system or device. In another example, one or more of the methods (e.g., process 1100, and/or other methods described herein) can be performed, in whole or in part, by the computing-device architecture 1500 shown in FIG. 15. For instance, a computing device with the computing-device architecture 1500 shown in FIG. 15 can include, or be included in, the components of the system 300, system 700, system 800, system 900, and/or system 1000 and can implement the operations of process 1100, and/or other process described herein. In some cases, the computing device or apparatus can include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device can include a display, a network interface configured to communicate and/or receive the data, any combination thereof, and/or other component(s). The network interface can be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

Process 1100, and/or other process described herein are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, process 1100, and/or other process described herein can be performed under the control of one or more computer systems configured with executable instructions and can be implemented as code (e.g., executable instructions, one or more computer programs, or one or more applications) executing collectively on one or more processors, by hardware, or combinations thereof. As noted above, the code can be stored on a computer-readable or machine-readable storage medium, for example, in the form of a computer program comprising a plurality of instructions executable by one or more processors. The computer-readable or machine-readable storage medium can be non-transitory.

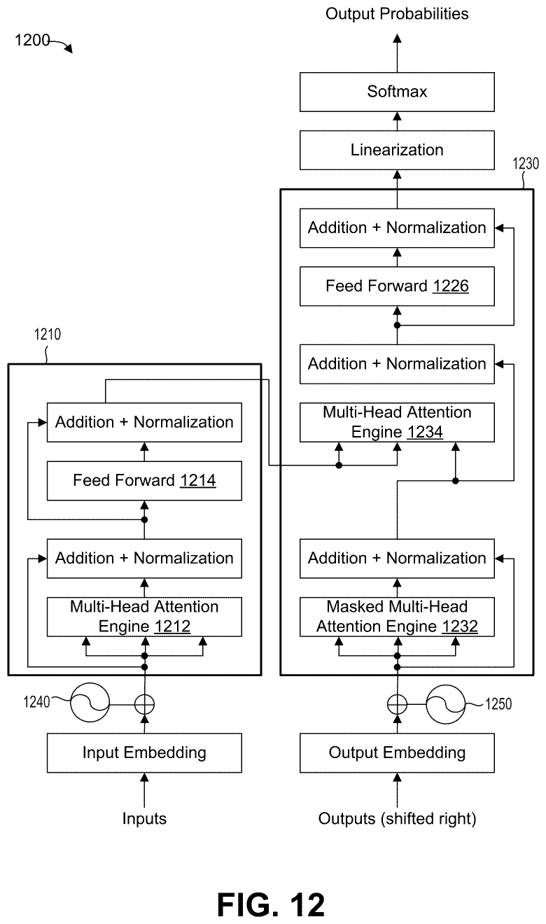

As described herein, an MOE model can utilize one or more transformers (e.g., a transformer block can include a set of expert feedforward network (FFN) layers). FIG. 12 is a block diagram of an example transformer, according to various aspects of the present disclosure. In a convolutional neural network (CNN) model, the number of operations required to relate signals from two arbitrary input or output positions grows in the distance between positions, which makes learning dependencies at different distant positions challenging for a CNN model. A transformer 1200 reduces the operations of learning dependencies by using an encoder 1210 and a decoder 1230 that implement an attention mechanism at different positions of a single sequence to compute a representation of that sequence. An attention function can be described as mapping a query and a set of key-value pairs to an output, where the query, keys, values, and output are all vectors. The output is computed as a weighted sum of the values, where the weight assigned to each value is computed by a compatibility function of the query with the corresponding key.

In one example of a transformer, the encoder 1210 is composed of a stack of six identical layers and each layer has two sub-layers. The first sub-layer is a multi-head self-attention engine 1212, and the second sub-layer is a fully-connected feed-forward network 1214. A residual connection (not shown) connects around each of the sub-layers followed by normalization.

In the example transformer 1200, the decoder 1230 is also composed of a stack of six (6) identical layers. The decoder also includes a masked multi-head self-attention engine 1232, a multi-head attention engine 1234 over the output of the encoder 1210, and a fully-connected feed-forward network 1226. Each layer includes a residual connection (not shown) around the layer, which is followed by layer normalization. The masked multi-head self-attention engine 1232 is masked to prevent positions from attending to subsequent positions and ensures that the predictions at position i can depend only on the known outputs at positions less than i (e.g., auto-regression).

In the transformer, the queries, keys, and values are linearly projected by a multi-head attention engine into learned linear projects, and then attention is performed in parallel on each of the learned linear projects, which are concatenated and then projected into final values.

The transformer also includes a positional encoder 1240 to encode positions because the model does not contain recurrence and convolution, and relative or absolute position of the tokens is needed. In the transformer 1200, the positional encodings are added to the input embeddings at the bottom layer of the encoder 1210 and the decoder 1230. The positional encodings are summed with the embeddings because the positional encodings and embeddings have the same dimensions. A corresponding position decoder 1250 is configured to decode the positions of the embeddings for the decoder 1230.

In some aspects, the transformer 1200 uses self-attention mechanisms to selectively weigh the importance of different parts of an input sequence during processing and allows the model to attend to different parts of the input sequence while generating the output. The input sequence is first embedded into vectors and then passed through multiple layers of self-attention and feed-forward networks. The transformer 1200 can process input sequences of variable length, making it well-suited for natural language processing tasks where input lengths can vary greatly. Additionally, the self-attention mechanism allows the transformer 1200 to capture long-range dependencies between words in the input sequence, which is difficult for Recurrent Neural Networks (RNNs) and CNNs. The transformer with self-attention has achieved results in several natural language processing tasks that are beyond the capabilities of other neural networks and has become a popular choice for language and text applications. For example, the various large language models, such as a generative pretrained transformer (e.g., ChatGPT, etc.) and other current models are types of transformer networks.

As noted above, various aspects of the present disclosure can use machine-learning models or systems.

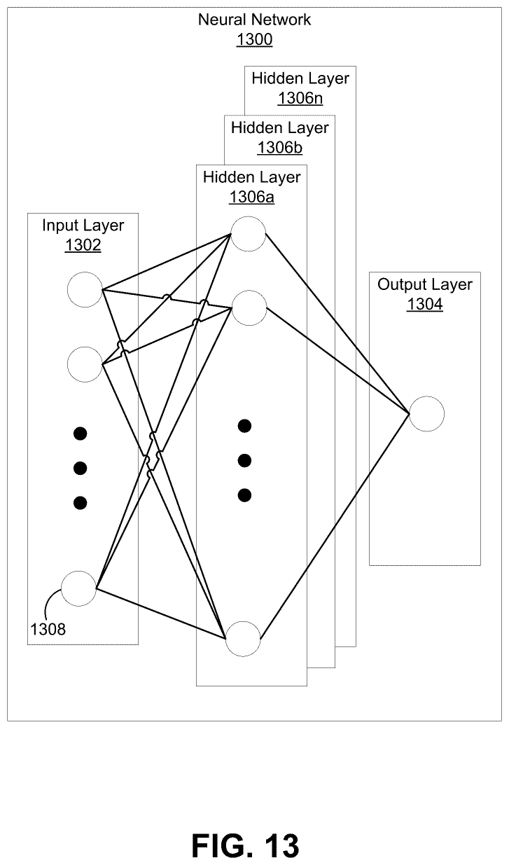

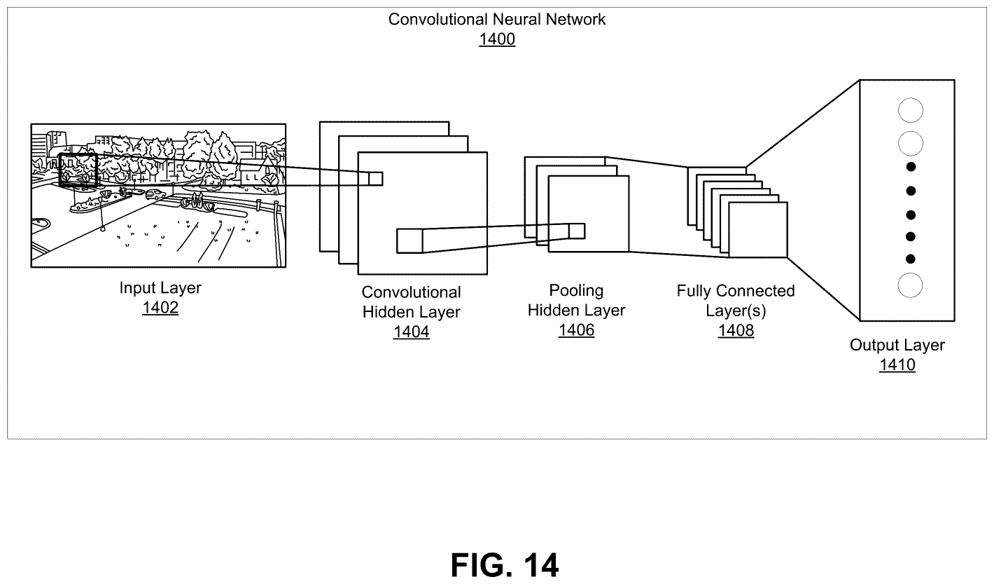

FIG. 13 is an illustrative example of a neural network 1300 (e.g., a deep-learning neural network) that can be used to implement machine-learning based feature segmentation, implicit-neural-representation generation, rendering, classification, object detection, image recognition (e.g., face recognition, object recognition, scene recognition, etc.), feature extraction, authentication, gaze detection, gaze prediction, and/or automation. For example, neural network 1300 may be an example of, or can implement, any of the experts described herein, (e.g., experts 304 of FIG. 3, experts 312 of FIG. 3, experts 406 of FIG. 4, experts 416 of FIG. 4, experts 426 of FIG. 4, experts 436 of FIG. 4), router MLP 702 of FIG. 7, router MLP 802 of FIG. 8, cache MLP 806 of FIG. 8, router MLP 902 of FIG. 9, cache MLP 906 of FIG. 9, and/or router model 1004 of FIG. 10.

An input layer 1302 includes input data. In one illustrative example, input layer 1302 can include data representing tokens (e.g., token 404 of FIG. 4, token 414 of FIG. 4, token 424 of FIG. 4, token 434 of FIG. 4 token 1002 of FIG. 10), hidden states hₜ (e.g., of FIG. 7, FIG. 8, and/or FIG. 9), and/or masks (e.g., \tilde{m}ₜ of FIG. 8 and FIG. 9).

Neural network 1300 includes multiple hidden layers, for example, hidden layers 1306a, 1306b, through 1306n. The hidden layers 1306a, 1306b, through hidden layer 1306n include “n” number of hidden layers, where “n” is an integer greater than or equal to one. The number of hidden layers can be made to include as many layers as needed for the given application. Neural network 1300 further includes an output layer 1304 that provides an output resulting from the processing performed by the hidden layers 1306a, 1306b, through 1306n. In one illustrative example, output layer 1304 can provide recommendations, for example, recommendation 534 of FIG. 5B, recommendation 544 of FIG. 5C, recommendation 602 of FIG. 6A, recommendation 612 of FIG. 6B, recommendation 1006 of FIG. 10, \tilde{p}ₜ of FIG. 7, FIG. 8 and/or FIG. 9, and/or β of FIG. 8 and/or FIG. 9.

Neural network 1300 may be, or may include, a multi-layer neural network of interconnected nodes. Each node can represent a piece of information. Information associated with the nodes is shared among the different layers and each layer retains information as information is processed. In some cases, neural network 1300 can include a feed-forward network, in which case there are no feedback connections where outputs of the network are fed back into itself. In some cases, neural network 1300 can include a recurrent neural network, which can have loops that allow information to be carried across nodes while reading in input.

Information can be exchanged between nodes through node-to-node interconnections between the various layers. Nodes of input layer 1302 can activate a set of nodes in the first hidden layer 1306a. For example, as shown, each of the input nodes of input layer 1302 is connected to each of the nodes of the first hidden layer 1306a. The nodes of first hidden layer 1306a can transform the information of each input node by applying activation functions to the input node information. The information derived from the transformation can then be passed to and can activate the nodes of the next hidden layer 1306b, which can perform their own designated functions. Example functions include convolutional, up-sampling, data transformation, and/or any other suitable functions. The output of the hidden layer 1306b can then activate nodes of the next hidden layer, and so on. The output of the last hidden layer 1306n can activate one or more nodes of the output layer 1304, at which an output is provided. In some cases, while nodes (e.g., node 1308) in neural network 1300 are shown as having multiple output lines, a node has a single output and all lines shown as being output from a node represent the same output value.

In some cases, each node or interconnection between nodes can have a weight that is a set of parameters derived from the training of neural network 1300. Once neural network 1300 is trained, it can be referred to as a trained neural network, which can be used to perform one or more operations. For example, an interconnection between nodes can represent a piece of information learned about the interconnected nodes. The interconnection can have a tunable numeric weight that can be tuned (e.g., based on a training dataset), allowing neural network 1300 to be adaptive to inputs and able to learn as more and more data is processed.

Neural network 1300 may be pre-trained to process the features from the data in the input layer 1302 using the different hidden layers 1306a, 1306b, through 1306n in order to provide the output through the output layer 1304. In an example in which neural network 1300 is used to identify features in images, neural network 1300 can be trained using training data that includes both images and labels, as described above. For instance, training images can be input into the network, with each training image having a label indicating the features in the images (for the feature-segmentation machine-learning system) or a label indicating classes of an activity in each image. In one example using object classification for illustrative purposes, a training image can include an image of a number 2, in which case the label for the image can be [0010000000].

In some cases, neural network 1300 can adjust the weights of the nodes using a training process called backpropagation. As noted above, a backpropagation process can include a forward pass, a loss function, a backward pass, and a weight update. The forward pass, loss function, backward pass, and parameter update are performed for one training iteration. The process can be repeated for a certain number of iterations for each set of training images until neural network 1300 is trained well enough so that the weights of the layers are accurately tuned.

For the example of identifying objects in images, the forward pass can include passing a training image through neural network 1300. The weights are initially randomized before neural network 1300 is trained. As an illustrative example, an image can include an array of numbers representing the pixels of the image. Each number in the array can include a value from 0 to 255 describing the pixel intensity at that position in the array. In one example, the array can include a 28×28×3 array of numbers with 28 rows and 28 columns of pixels and 3 color components (such as red, green, and blue, or luma and two chroma components, or the like).

As noted above, for a first training iteration for neural network 1300, the output will likely include values that do not give preference to any particular class due to the weights being randomly selected at initialization. For example, if the output is a vector with probabilities that the object includes different classes, the probability value for each of the different classes can be equal or at least very similar (e.g., for ten possible classes, each class can have a probability value of 0.1). With the initial weights, neural network 1300 is unable to determine low-level features and thus cannot make an accurate determination of what the classification of the object might be. A loss function can be used to analyze error in the output. Any suitable loss function definition can be used, such as a cross-entropy loss. Another example of a loss function includes the mean squared error (MSE), defined as Eₜₒₜₐₗ=Σ½ (target-output) 2. The loss can be set to be equal to the value of Eₜₒₜₐₗ.

The loss (or error) will be high for the first training images since the actual values will be much different than the predicted output. The goal of training is to minimize the amount of loss so that the predicted output is the same as the training label. Neural network 1300 can perform a backward pass by determining which inputs (weights) most contributed to the loss of the network and can adjust the weights so that the loss decreases and is eventually minimized. A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as w=wᵢ−η dL/dW, where w denotes a weight, wᵢ denotes the initial weight, and η denotes a learning rate. The learning rate can be set to any suitable value, with a high learning rate including larger weight updates and a lower value indicating smaller weight updates.

Neural network 1300 can include any suitable deep network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. Neural network 1300 can include any other deep network other than a CNN, such as an autoencoder, a deep belief nets (DBNs), a Recurrent Neural Networks (RNNs), among others.

FIG. 14 is an illustrative example of a convolutional neural network (CNN) 1400. The input layer 1402 of the CNN 1400 includes data representing an image or frame. For example, the data can include an array of numbers representing the pixels of the image, with each number in the array including a value from 0 to 255 describing the pixel intensity at that position in the array. Using the previous example from above, the array can include a 28×28×3 array of numbers with 28 rows and 28 columns of pixels and 3 color components (e.g., red, green, and blue, or luma and two chroma components, or the like). The image can be passed through a convolutional hidden layer 1404, an optional non-linear activation layer, a pooling hidden layer 1406, and fully connected layer 1408 (which fully connected layer 1408 can be hidden) to get an output at the output layer 1410. While only one of each hidden layer is shown in FIG. 14, one of ordinary skill will appreciate that multiple convolutional hidden layers, non-linear layers, pooling hidden layers, and/or fully connected layers can be included in the CNN 1400. As previously described, the output can indicate a single class of an object or can include a probability of classes that best describe the object in the image.

The first layer of the CNN 1400 can be the convolutional hidden layer 1404. The convolutional hidden layer 1404 can analyze image data of the input layer 1402. Each node of the convolutional hidden layer 1404 is connected to a region of nodes (pixels) of the input image called a receptive field. The convolutional hidden layer 1404 can be considered as one or more filters (each filter corresponding to a different activation or feature map), with each convolutional iteration of a filter being a node or neuron of the convolutional hidden layer 1404. For example, the region of the input image that a filter covers at each convolutional iteration would be the receptive field for the filter. In one illustrative example, if the input image includes a 28×28 array, and each filter (and corresponding receptive field) is a 5×5 array, then there will be 24×24 nodes in the convolutional hidden layer 1404. Each connection between a node and a receptive field for that node learns a weight and, in some cases, an overall bias such that each node learns to analyze its particular local receptive field in the input image. Each node of the convolutional hidden layer 1404 will have the same weights and bias (called a shared weight and a shared bias). For example, the filter has an array of weights (numbers) and the same depth as the input. A filter will have a depth of 3 for an image frame example (according to three color components of the input image). An illustrative example size of the filter array is 5×5×3, corresponding to a size of the receptive field of a node.

The convolutional nature of the convolutional hidden layer 1404 is due to each node of the convolutional layer being applied to its corresponding receptive field. For example, a filter of the convolutional hidden layer 1404 can begin in the top-left corner of the input image array and can convolve around the input image. As noted above, each convolutional iteration of the filter can be considered a node or neuron of the convolutional hidden layer 1404. At each convolutional iteration, the values of the filter are multiplied with a corresponding number of the original pixel values of the image (e.g., the 5×5 filter array is multiplied by a 5×5 array of input pixel values at the top-left corner of the input image array). The multiplications from each convolutional iteration can be summed together to obtain a total sum for that iteration or node. The process is next continued at a next location in the input image according to the receptive field of a next node in the convolutional hidden layer 1404. For example, a filter can be moved by a step amount (referred to as a stride) to the next receptive field. The stride can be set to 1 or any other suitable amount. For example, if the stride is set to 1, the filter will be moved to the right by 1 pixel at each convolutional iteration. Processing the filter at each unique location of the input volume produces a number representing the filter results for that location, resulting in a total sum value being determined for each node of the convolutional hidden layer 1404.

The mapping from the input layer to the convolutional hidden layer 1404 is referred to as an activation map (or feature map). The activation map includes a value for each node representing the filter results at each location of the input volume. The activation map can include an array that includes the various total sum values resulting from each iteration of the filter on the input volume. For example, the activation map will include a 24×24 array if a 5×5 filter is applied to each pixel (a stride of 1) of a 28×28 input image. The convolutional hidden layer 1404 can include several activation maps in order to identify multiple features in an image. The example shown in FIG. 14 includes three activation maps. Using three activation maps, the convolutional hidden layer 1404 can detect three different kinds of features, with each feature being detectable across the entire image.

In some examples, a non-linear hidden layer can be applied after the convolutional hidden layer 1404. The non-linear layer can be used to introduce non-linearity to a system that has been computing linear operations. One illustrative example of a non-linear layer is a rectified linear unit (ReLU) layer. A ReLU layer can apply the function ƒ(x)=max(0, x) to all of the values in the input volume, which changes all the negative activations to 0. The ReLU can thus increase the non-linear properties of the CNN 1400 without affecting the receptive fields of the convolutional hidden layer 1404.

The pooling hidden layer 1406 can be applied after the convolutional hidden layer 1404 (and after the non-linear hidden layer when used). The pooling hidden layer 1406 is used to simplify the information in the output from the convolutional hidden layer 1404. For example, the pooling hidden layer 1406 can take each activation map output from the convolutional hidden layer 1404 and generates a condensed activation map (or feature map) using a pooling function. Max-pooling is one example of a function performed by a pooling hidden layer. Other forms of pooling functions be used by the pooling hidden layer 1406, such as average pooling, L2-norm pooling, or other suitable pooling functions. A pooling function (e.g., a max-pooling filter, an L2-norm filter, or other suitable pooling filter) is applied to each activation map included in the convolutional hidden layer 1404. In the example shown in FIG. 14, three pooling filters are used for the three activation maps in the convolutional hidden layer 1404.

In some examples, max-pooling can be used by applying a max-pooling filter (e.g., having a size of 2×2) with a stride (e.g., equal to a dimension of the filter, such as a stride of 2) to an activation map output from the convolutional hidden layer 1404. The output from a max-pooling filter includes the maximum number in every sub-region that the filter convolves around. Using a 2×2 filter as an example, each unit in the pooling layer can summarize a region of 2×2 nodes in the previous layer (with each node being a value in the activation map). For example, four values (nodes) in an activation map will be analyzed by a 2×2 max-pooling filter at each iteration of the filter, with the maximum value from the four values being output as the “max” value. If such a max-pooling filter is applied to an activation filter from the convolutional hidden layer 1404 having a dimension of 24×24 nodes, the output from the pooling hidden layer 1406 will be an array of 12×12 nodes.

In some examples, an L2-norm pooling filter could also be used. The L2-norm pooling filter includes computing the square root of the sum of the squares of the values in the 2×2 region (or other suitable region) of an activation map (instead of computing the maximum values as is done in max-pooling) and using the computed values as an output.

The pooling function (e.g., max-pooling, L2-norm pooling, or other pooling function) determines whether a given feature is found anywhere in a region of the image and discards the exact positional information. This can be done without affecting results of the feature detection because, once a feature has been found, the exact location of the feature is not as important as its approximate location relative to other features. Max-pooling (as well as other pooling methods) offer the benefit that there are many fewer pooled features, thus reducing the number of parameters needed in later layers of the CNN 1400.

The final layer of connections in the network is a fully-connected layer that connects every node from the pooling hidden layer 1406 to every one of the output nodes in the output layer 1410. Using the example above, the input layer includes 28×28 nodes encoding the pixel intensities of the input image, the convolutional hidden layer 1404 includes 3×24×24 hidden feature nodes based on application of a 5×5 local receptive field (for the filters) to three activation maps, and the pooling hidden layer 1406 includes a layer of 3×12×12 hidden feature nodes based on application of max-pooling filter to 2×2 regions across each of the three feature maps. Extending this example, the output layer 1410 can include ten output nodes. In such an example, every node of the 3×12×12 pooling hidden layer 1406 is connected to every node of the output layer 1410.

The fully connected layer 1408 can obtain the output of the previous pooling hidden layer 1406 (which should represent the activation maps of high-level features) and determines the features that most correlate to a particular class. For example, the fully connected layer 1408 can determine the high-level features that most strongly correlate to a particular class and can include weights (nodes) for the high-level features. A product can be computed between the weights of the fully connected layer 1408 and the pooling hidden layer 1406 to obtain probabilities for the different classes. For example, if the CNN 1400 is being used to predict that an object in an image is a person, high values will be present in the activation maps that represent high-level features of people (e.g., two legs are present, a face is present at the top of the object, two eyes are present at the top left and top right of the face, a nose is present in the middle of the face, a mouth is present at the bottom of the face, and/or other features common for a person).

In some examples, the output from the output layer 1410 can include an M-dimensional vector (in the prior example, M=10). M indicates the number of classes that the CNN 1400 has to choose from when classifying the object in the image. Other example outputs can also be provided. Each number in the M-dimensional vector can represent the probability the object is of a certain class. In one illustrative example, if a 10-dimensional output vector represents ten different classes of objects is [0 0 0.05 0.8 0 0.15 0 0 0 0], the vector indicates that there is a 5% probability that the image is the third class of object (e.g., a dog), an 80% probability that the image is the fourth class of object (e.g., a human), and a 15% probability that the image is the sixth class of object (e.g., a kangaroo). The probability for a class can be considered a confidence level that the object is part of that class.

FIG. 15 illustrates an example computing-device architecture 1500 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. For example, the computing-device architecture 1500 may include, implement, or be included in any or all of system 300 of FIG. 3, system 700 of FIG. 7, system 800 of FIG. 8, system 900 of FIG. 9, system 1000 of FIG. 10, and/or other devices, modules, or systems described herein. Additionally or alternatively, computing-device architecture 1500 may be configured to perform process 1100, and/or other process described herein.

The components of computing-device architecture 1500 are shown in electrical communication with each other using connection 1512, such as a bus. The example computing-device architecture 1500 includes a processing unit (CPU or processor) 1502 and computing device connection 1512 that couples various computing device components including computing device memory 1510, such as read only memory (ROM) 1508 and random-access memory (RAM) 1506, to processor 1502.

Computing-device architecture 1500 can include a cache of high-speed memory connected directly with, in close proximity to, or integrated as part of processor 1502. Computing-device architecture 1500 can copy data from memory 1510 and/or the storage device 1514 to cache 1504 for quick access by processor 1502. In this way, the cache can provide a performance boost that avoids processor 1502 delays while waiting for data. These and other modules can control or be configured to control processor 1502 to perform various actions. Other computing device memory 1510 may be available for use as well. Memory 1510 can include multiple different types of memory with different performance characteristics. Processor 1502 can include any general-purpose processor and a hardware or software service, such as service 1 1516, service 2 1518, and service 3 1520 stored in storage device 1514, configured to control processor 1502 as well as a special-purpose processor where software instructions are incorporated into the processor design. Processor 1502 may be a self-contained system, containing multiple cores or processors, a bus, memory controller, cache, etc. A multi-core processor may be symmetric or asymmetric.

To enable user interaction with the computing-device architecture 1500, input device 1522 can represent any number of input mechanisms, such as a microphone for speech, a touch-sensitive screen for gesture or graphical input, keyboard, mouse, motion input, speech and so forth. Output device 1524 can also be one or more of a number of output mechanisms known to those of skill in the art, such as a display, projector, television, speaker device, etc. In some instances, multimodal computing devices can enable a user to provide multiple types of input to communicate with computing-device architecture 1500. Communication interface 1526 can generally govern and manage the user input and computing device output. There is no restriction on operating on any particular hardware arrangement and therefore the basic features here may easily be substituted for improved hardware or firmware arrangements as they are developed.

Storage device 1514 is a non-volatile memory and can be a hard disk or other types of computer readable media which can store data that are accessible by a computer, such as magnetic cassettes, flash memory cards, solid state memory devices, digital versatile discs (DVDs), cartridges, random-access memories (RAMs) 1506, read only memory (ROM) 1508, and hybrids thereof. Storage device 1514 can include services 1516, 1518, and 1520 for controlling processor 1502. Other hardware or software modules are contemplated. Storage device 1514 can be connected to the computing device connection 1512. In one aspect, a hardware module that performs a particular function can include the software component stored in a computer-readable medium in connection with the necessary hardware components, such as processor 1502, connection 1512, output device 1524, and so forth, to carry out the function.

The term “substantially,” in reference to a given parameter, property, or condition, may refer to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific aspects. For example, a system may be implemented on one or more printed circuit boards or other substrates and may have movable or static components. While the below description and examples use the term “system” to describe various aspects of this disclosure, the term “system” is not limited to a specific configuration, type, or number of objects.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, magnetic or optical disks, USB devices provided with non-volatile memory, networked storage devices, any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general-purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods described above. The computer-readable data storage medium may form part of a computer program product, which may include packaging materials. The computer-readable medium may include memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), flash memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general-purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, such as, a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:
Aspect 1. An apparatus for processing tokens, the apparatus comprising: at least one memory; and at least one processor coupled to the at least one memory and configured to: process a token at a router model to generate a recommendation a subset of expert models from a plurality of expert models to use for further processing of the token; select a number of expert models to use for the further processing of the token based on the recommendation of the subset of expert models and based on cached expert models of the plurality of expert models stored in a cache memory; and process the token using the selected number of expert models.
Aspect 2. The apparatus of aspect 1, wherein the cached expert models are loaded into the cache memory to process a previous token.
Aspect 3. The apparatus of any one of aspects 1 or 2, wherein the at least one processor is configured to: remove a first expert model of the cached expert models from the cache memory based on the first expert model not being among the selected number of expert models; and load a second expert model of the plurality of expert models from a memory into the cache memory based on the second expert model being among the selected number of expert models.
Aspect 4. The apparatus of any one of aspects 1 to 3, wherein the at least one processor is configured to process the token using the selected number of expert models based on the selected number of expert models being among the cached expert models.
Aspect 5. The apparatus of any one of aspects 1 to 4, wherein the recommendation comprises a respective expert-model rank of each expert model of the plurality of expert models, wherein the at least one processor is configured to select the number of expert models based on the respective expert-model rank of each expert model of the plurality of expert models.
Aspect 6. The apparatus of aspect 5, wherein the at least one processor is configured to select a highest-ranked expert model of the plurality of expert models to be among the selected number of expert models.
Aspect 7. The apparatus of any one of aspects 5 or 6, wherein the at least one processor is configured to select an expert model from among the cached expert models to be among the selected number of expert models based on an expert-model rank of the expert model exceeding a ranking threshold.
Aspect 8. The apparatus of any one of aspects 5 to 7, wherein the at least one processor is configured to, based on expert-model ranks of the cached expert models not exceeding a ranking threshold, select the number of expert models from among expert models not loaded into the cache memory.
Aspect 9. The apparatus of any one of aspects 1 to 8, wherein the recommendation comprises a respective probability of each expert model of the plurality of expert models, wherein the at least one processor is configured to select the number of expert models based on the respective probability of each expert model of the plurality of expert models.
Aspect 10. The apparatus of aspect 9, wherein the at least one processor is configured to: identify probable expert models from among the plurality of expert models based on a sum of probabilities associated with the probable expert models exceeding a probability threshold; and select an expert model from among the cached expert models to be among the selected number of expert models based on the expert model being among the probable expert models.
Aspect 11. The apparatus of any one of aspects 9 or 10, wherein the at least one processor is configured to: identify probable expert models from among the plurality of expert models based on a sum of probabilities associated with the probable expert models exceeding a probability threshold; and based on the cached expert models not being among the probable expert models, select the number of expert models from among expert models not loaded into the cache memory.
Aspect 12. The apparatus of any one of aspects 1 to 11, wherein the recommendation comprises a respective output value of each expert model of the plurality of expert models, wherein the at least one processor is configured to select the number of expert models based on the output values of the plurality of expert models and output values of the cached expert models.
Aspect 13. The apparatus of aspect 12, wherein the at least one processor is configured to select a highest-valued expert model of the plurality of expert models to be among the selected number of expert models.
Aspect 14. The apparatus of any one of aspects 12 or 13, wherein the at least one processor is configured to increase biasing the output values of the cached expert models for selecting the number of expert models.
Aspect 15. The apparatus of aspect 14, wherein the output values of the cached expert models are biased by a predetermined amount.
Aspect 16. The apparatus of any one of aspects 12 to 15, wherein the at least one processor is configured to: process the output values of the plurality of expert models and a mask indicative of the cached expert models using a machine-learning model to generate biasing values; and bias the output values of the cached expert models according to the biasing values for selecting the number of expert models.
Aspect 17. The apparatus of aspect 16, wherein the at least one processor is configured to process router input values using the machine-learning model to generate the biasing values.
Aspect 18. A method for processing tokens, the method comprising: processing a token at a router model to generate a recommendation a subset of expert models from a plurality of expert models to use for further processing of the token; selecting a number of expert models to use for the further processing of the token based on the recommendation of the subset of expert models and based on cached expert models of the plurality of expert models stored in a cache memory; and processing the token using the selected number of expert models.
Aspect 19. The method of aspect 18, wherein the cached expert models are loaded into the cache memory to process a previous token.
Aspect 20. The method of any one of aspects 18 or 19, further comprising: removing a first expert model of the cached expert models from the cache memory based on the first expert model not being among the selected number of expert models; and loading a second expert model of the plurality of expert models from a memory into the cache memory based on the second expert model being among the selected number of expert models.
Aspect 21. The method of any one of aspects 18 to 20, further comprising processing the token using the selected number of expert models based on the selected number of expert models being among the cached expert models.
Aspect 22. The method of any one of aspects 18 to 21, wherein the recommendation comprises a respective expert-model rank of each expert model of the plurality of expert models, the method further comprising selecting the number of expert models based on the respective expert-model rank of each expert model of the plurality of expert models.
Aspect 23. The method of aspect 22, further comprising selecting a highest-ranked expert model of the plurality of expert models to be among the selected number of expert models.
Aspect 24. The method of any one of aspects 22 or 23, further comprising selecting an expert model from among the cached expert models to be among the selected number of expert models based on an expert-model rank of the expert model exceeding a ranking threshold.
Aspect 25. The method of any one of aspects 22 to 24, further comprising, based on expert-model ranks of the cached expert models not exceeding a ranking threshold, selecting the number of expert models from among expert models not loaded into the cache memory.
Aspect 26. The method of any one of aspects 18 to 25, wherein the recommendation comprises a respective probability of each expert model of the plurality of expert models, the method further comprising selecting the number of expert models based on the respective probability of each expert model of the plurality of expert models.
Aspect 27. The method of aspect 26, further comprising: identifying probable expert models from among the plurality of expert models based on a sum of probabilities associated with the probable expert models exceeding a probability threshold; and selecting an expert model from among the cached expert models to be among the selected number of expert models based on the expert model being among the probable expert models.
Aspect 28. The method of any one of aspects 26 or 27, further comprising: identifying probable expert models from among the plurality of expert models based on a sum of probabilities associated with the probable expert models exceeding a probability threshold; and based on the cached expert models not being among the probable expert models, selecting the number of expert models from among expert models not loaded into the cache memory.
Aspect 29. The method of any one of aspects 18 to 28, wherein the recommendation comprises a respective output value of each expert model of the plurality of expert models, the method further comprising selecting the number of expert models based on the output values of the plurality of expert models and output values of the cached expert models.
Aspect 30. The method of aspect 29, further comprising selecting a highest-valued expert model of the plurality of expert models to be among the selected number of expert models.
Aspect 31. The method of any one of aspects 29 or 30, further comprising increasing biasing the output values of the cached expert models for selecting the number of expert models.
Aspect 32. The method of aspect 31, wherein the output values of the cached expert models are biased by a predetermined amount.
Aspect 33. The method of any one of aspects 29 to 32, further comprising: processing the output values of the plurality of expert models and a mask indicative of the cached expert models using a machine-learning model to generate biasing values; and biasing the output values of the cached expert models according to the biasing values for selecting the number of expert models.
Aspect 34. The method of aspect 33, further comprising processing router input values using the machine-learning model to generate the biasing values.
Aspect 35. A non-transitory computer-readable storage medium having stored thereon instructions that, when executed by at least one processor, cause the at least one processor to perform operations according to any of aspects 18 to 34.
Aspect 36. An apparatus for providing virtual content for display, the apparatus comprising one or more means for perform operations according to any of aspects 18 to 34.

What is claimed is:

1. An apparatus for processing tokens, the apparatus comprising:
at least one memory, including a cache memory and a memory; and
at least one processor coupled to the at least one memory and configured to:
process a token at a router model to generate a recommendation of a subset of expert models from a plurality of expert models to use for further processing of the token;
select a number of expert models to use for the further processing of the token based on the recommendation of the subset of expert models and based on cached expert models of the plurality of expert models stored in the cache memory; and
process the token using the selected number of expert models.

2. The apparatus of claim 1, wherein the cached expert models are loaded into the cache memory to process a previous token.

3. The apparatus of claim 1, wherein the at least one processor is configured to:
remove a first expert model of the cached expert models from the cache memory based on the first expert model not being among the selected number of expert models; and
load a second expert model of the plurality of expert models from the memory into the cache memory based on the second expert model being among the selected number of expert models.

4. The apparatus of claim 1, wherein the at least one processor is configured to process the token using the selected number of expert models based on the selected number of expert models being among the cached expert models.

5. The apparatus of claim 1, wherein the recommendation comprises a respective expert-model rank of each expert model of the plurality of expert models, wherein the at least one processor is configured to select the number of expert models based on the respective expert-model rank of each expert model of the plurality of expert models.

6. The apparatus of claim 5, wherein the at least one processor is configured to select a highest-ranked expert model of the plurality of expert models to be among the selected number of expert models.

7. The apparatus of claim 5, wherein the at least one processor is configured to select an expert model from among the cached expert models to be among the selected number of expert models based on an expert-model rank of the expert model exceeding a ranking threshold.

8. The apparatus of claim 5, wherein the at least one processor is configured to, based on expert-model ranks of the cached expert models not exceeding a ranking threshold, select the number of expert models from among expert models not loaded into the cache memory.

9. The apparatus of claim 1, wherein the recommendation comprises a respective probability of each expert model of the plurality of expert models, wherein the at least one processor is configured to select the number of expert models based on the respective probability of each expert model of the plurality of expert models.

10. The apparatus of claim 9, wherein the at least one processor is configured to:
identify probable expert models from among the plurality of expert models based on a sum of probabilities associated with the probable expert models exceeding a probability threshold; and
select an expert model from among the cached expert models to be among the selected number of expert models based on the expert model being among the probable expert models.

11. The apparatus of claim 9, wherein the at least one processor is configured to:
identify probable expert models from among the plurality of expert models based on a sum of probabilities associated with the probable expert models exceeding a probability threshold; and
based on the cached expert models not being among the probable expert models, select the number of expert models from among expert models not loaded into the cache memory.

12. The apparatus of claim 1, wherein the recommendation comprises a respective output value of each expert model of the plurality of expert models, wherein the at least one processor is configured to select the number of expert models based on the output values of the plurality of expert models and output values of the cached expert models.

13. The apparatus of claim 12, wherein the at least one processor is configured to select a highest-valued expert model of the plurality of expert models to be among the selected number of expert models.

14. The apparatus of claim 12, wherein the at least one processor is configured to increase biasing the output values of the cached expert models for selecting the number of expert models.

15. The apparatus of claim 14, wherein the output values of the cached expert models are biased by a predetermined amount.

16. The apparatus of claim 12, wherein the at least one processor is configured to:
process the output values of the plurality of expert models and a mask indicative of the cached expert models using a machine-learning model to generate biasing values; and
bias the output values of the cached expert models according to the biasing values for selecting the number of expert models.

17. The apparatus of claim 16, wherein the at least one processor is configured to process router input values using the machine-learning model to generate the biasing values.

18. A method for processing tokens, the method comprising:
processing a token at a router model to generate a recommendation a subset of expert models from a plurality of expert models to use for further processing of the token;
selecting a number of expert models to use for the further processing of the token based on the recommendation of the subset of expert models and based on cached expert models of the plurality of expert models stored in a cache memory; and
processing the token using the selected number of expert models.

19. The method of claim 18, wherein the cached expert models are loaded into the cache memory to process a previous token.

20. The method of claim 18, further comprising:
removing a first expert model of the cached expert models from the cache memory based on the first expert model not being among the selected number of expert models; and
loading a second expert model of the plurality of expert models from a memory into the cache memory based on the second expert model being among the selected number of expert models.

21. The method of claim 18, further comprising processing the token using the selected number of expert models based on the selected number of expert models being among the cached expert models.

22. The method of claim 18, wherein the recommendation comprises a respective expert-model rank of each expert model of the plurality of expert models, the method further comprising selecting the number of expert models based on the respective expert-model rank of each expert model of the plurality of expert models.

23. The method of claim 22, further comprising selecting a highest-ranked expert model of the plurality of expert models to be among the selected number of expert models.

24. The method of claim 22, further comprising selecting an expert model from among the cached expert models to be among the selected number of expert models based on an expert-model rank of the expert model exceeding a ranking threshold.

25. The method of claim 22, further comprising, based on expert-model ranks of the cached expert models not exceeding a ranking threshold, selecting the number of expert models from among expert models not loaded into the cache memory.

26. The method of claim 18, wherein the recommendation comprises a respective probability of each expert model of the plurality of expert models, the method further comprising selecting the number of expert models based on the respective probability of each expert model of the plurality of expert models.

27. The method of claim 26, further comprising:
identifying probable expert models from among the plurality of expert models based on a sum of probabilities associated with the probable expert models exceeding a probability threshold; and
selecting an expert model from among the cached expert models to be among the selected number of expert models based on the expert model being among the probable expert models.

28. The method of claim 26, further comprising:
identifying probable expert models from among the plurality of expert models based on a sum of probabilities associated with the probable expert models exceeding a probability threshold; and
based on the cached expert models not being among the probable expert models, selecting the number of expert models from among expert models not loaded into the cache memory.

29. The method of claim 18, wherein the recommendation comprises a respective output value of each expert model of the plurality of expert models, the method further comprising selecting the number of expert models based on the output values of the plurality of expert models and output values of the cached expert models.

30. The method of claim 29, further comprising selecting a highest-valued expert model of the plurality of expert models to be among the selected number of expert models.

31. The method of claim 29, further comprising increasing biasing the output values of the cached expert models for selecting the number of expert models.

32. The method of claim 31, wherein the output values of the cached expert models are biased by a predetermined amount.

33. The method of claim 29, further comprising:
processing the output values of the plurality of expert models and a mask indicative of the cached expert models using a machine-learning model to generate biasing values; and
biasing the output values of the cached expert models according to the biasing values for selecting the number of expert models.

34. The method of claim 33, further comprising processing router input values using the machine-learning model to generate the biasing values.
